(19) United States
(12) Patent Application Publication
(10) Pub. No.: US 2004/0003120 A1
(43) Pub. Date: Jan. 1, 2004

(54) Digital data broadcasting program producing apparatus

(76) Inventors: Akira Nagano, Saitama (JP); Hideki Matsumoto, Kanagawa (JP)

Correspondence Address: FROMMER LAWRENCE & HAUG LLP, 745 FIFTH AVENUE, NEW YORK, NY, 10151, US

(21) Appl. No.: 10/370,947

(22) Filed: Feb. 20, 2003

(30) Foreign Application Priority Data
Feb. 21, 2002 (JP) 2002-044823

(51) Int. Cl. G06F 15/16

(52) U.S. Cl. 709/246

(57) ABSTRACT

A digital data broadcasting program producing apparatus is provided, in which the content of a digital data broadcasting program is produced on the Web by using an application through a network. As a result, costs are considerably reduced and efficiency is enhanced. The apparatus is provided with a client terminal which has a function of being connected with a network such as the Internet and the like and can produce the content of the data broadcasting program, and a Web server capable of accessing the network to be connected with the client terminal. The client terminal produces the content of the data broadcasting program on the Web by means of a software for producing the data broadcasting program. The software may reside in the Web server.

### CROSS REFERENCE TO RELATED APPLICATIONS

This application claims priority to Japanese Patent Application No. JP 2002-044823, filed on Feb. 21, 2002, the disclosure of such application being herein incorporated by reference to the extent permitted by law.

### BACKGROUND OF THE INVENTION

1. Field of the Invention

The present invention relates to a digital data broadcasting program producing apparatus, and more specifically to a digital data broadcasting program producing apparatus capable of producing content to be used to a data broadcasting program on the Web through a network such as the Internet and the like.

2. Related Art

A demand on production of content for data broadcasting is on increase owing to the recent introduction of communication satellite (CS) digital broadcasting and a broadcasting satellite (BS) digital broadcasting, and in addition to them, owing to a schedule on the commencement of a ground wave digital broadcasting in 2003. Consequently, content producing business is also showing a trend of increase.

### SUMMARY OF THE INVENTION

However, prices of software programs for content producing available in the market are high. Also, there is a limitation such that such software can be developed on only one computer on which a development environment is installed. As a result, for developing a plurality of pieces of content simultaneously, a content producing company has to purchase as many content producing software programs as there is a number of computers for development. Consequently, there is a problem in which the content producing company has to make high investment on equipment.

Moreover, if a problem is discovered in the content producing software, or, if the standards of data broadcasting in digital broadcasting which are enacted by the Association of Radio Industries and Businesses (ARIB) is updated, then the software developing company is required to perform an update corresponding to the problem or the updated standards for each software user after the development of the software, in order to cope with the problem or to comply with the updated standards. Consequently, there is also a problem in which there is required a number of man-hours and an estimated cost for the update which bears to the software developing company, and the problem in which an update of content producing software of a software user (a company which has purchased the software) cannot be performed in real time.

Moreover, as there might be a particular environment under which the operation cannot be carried out satisfactorily, the development of content and a process of update requires tests under various operation environments, thus incurring also in the problem in which the number of required man-hours for the tests becomes huge.

Moreover, though content development software provides various functions, there is also the case where a content producer needs only one of them. However, under the existing current circumstances, the content producer has no choice other than to purchase a high-priced piece of content producing software as a whole, even if the content producer wanted to use only one function of the content producing software. Consequently, there is also the problem in which the content producing company has to make an inefficient investment on equipment.

Moreover, the produced content has to be submitted to a variety of tests. The tests are not always performed on a computer in which the content producing software is installed. Consequently, if a problem occurs during a test at a place where there is no computer in which the content producing software is installed, then the content has to be brought back to a place where there is a computer in which the content producing software is installed in order to amend the content having the problem. Then, one should again move to the place where the test of the content is executed. Consequently, there is the problem of speed of the measures that are taken for the repair. There is also the problem the unnecessary number of man-hours are spent as a result.

In addition, in the case where content is newly produced, the content is produced in accordance with the following procedure. The procedure first begins from the production of ca design of the content. Then, the procedure is followed by the generation of a mono-medium by the use of various tools available on the market, by the programming of content using Broadcast Markup Language (BML: a page description language for data broadcasting based on Extensible Markup Language (XML) and introduced by the ARIB), and by the verification of the content.

Each step of production expends a considerable amount of man-hours. Moreover, various tools are necessary for producing a piece of content, and thereby huge equipment investment must be made. In addition, because the content and the mono-medium which have been produced in accordance with the above-mentioned procedure are made to be used only for the produced content without intension of multi-use, there is the problem in which it is difficult to reutilize them for other content.

Accordingly, there is a need for providing a system by which a content producing person can produce content without going to a place where a computer in which content producing software is installed, and by which the person can also amend the content and the like.

By driving a software for producing the content of a data broadcasting program on the Web through a network, it becomes unnecessary for such a system to provide the software for producing the content to a terminal on each client side, and thereby the amount of investment for purchasing the software can be reduced.

On the other hand, it becomes unnecessary for a service enterpriser who supplies software for producing content to provide the software for producing content to a terminal on each client side, and the unitary management of the software for producing content becomes easy to perform.

As described above, by means of a digital data broadcasting program producing apparatus according to the present invention, it becomes unnecessary for a content producing company to purchase high-priced content producing applications as many as the number of computers performing development. As a result, the amount of investment for purchasing software can be reduced. In addition, if the content producing company wants to use a specific function, the company is not required to purchase software including the function, but the company may purchase only the necessary function. Consequently, the digital data broadcasting program producing apparatus has the advantage that a content producing company can use a necessary function under a minimum investment.

Moreover, from the fact that a user of a service on a client side uses various services, the costs and the number of man-hours required for development of content are drastically reduced. As a result, not only the costs and the number of man-hours of human resources are reduced, but also the maintenance and the management of content producing software become very simpler and easier because it is unnecessary to install the content producing software in each computer.

In addition, the digital data broadcasting program producing apparatus has also the following advantages. That is, because all terminals are made to be ones with which content can be produced as long as they can be connected with a network, there is no necessity to prepare a computer to be exclusively used for producing the content. Moreover, the content can be produced at any place regardless of the place as long as a computer for producing the content is in an environment in which a terminal can be connected with a network.

Moreover, the following advantages can be obtained. That is, even if standards regulated by the ARIB are changed, or if software is updated, it is sufficient only to update the application on a Web server's side. Consequently, a user of a service on the client side can perform development of content without having to worry about the update, and the user can produce the content upon using the latest available content producing application

### BRIEF DESCRIPTION OF THE DRAWINGS

The above and other features and advantages of the present invention will become more apparent to those skilled in the art from the following description of the present exemplary preferred embodiments of the present invention taken in conjunction with the accompanying drawings, in which:

FIG. 1 is a schematic diagram showing an overall view of a digital data broadcasting program producing apparatus according to a first preferred embodiment of the present invention;

FIG. 2 is a block diagram showing transitions of screens on the Web in the system according to a preferred embodiment of the present invention;

FIG. 3 is a flow chart of a TOP service in the transitions of screens on the Web in the system according to a preferred embodiment of the present invention;

FIG. 4 is a flow chart of a content data storage service in the transitions of screens on the Web in the system according to a preferred embodiment of the present invention;

FIG. 5 is a flow chart of a content producing service in the transitions of screens on the Web in the system according to a preferred embodiment of the present invention;

FIG. 6 is a flow chart of a content reproducing service in the transitions of screens on the Web in the system according to a preferred embodiment of the present invention;

FIG. 7 is a flow chart of a content checking service in the transitions of screens on the Web in the system according to a preferred embodiment of the present invention;

FIG. 8 is a flow chart of a binary table file producing service in the transitions of screens on the Web in the system according to a preferred embodiment of the present invention;

FIG. 9 is a flow chart of a mono-media checking service in the transitions of screens on the Web in the system according to a preferred embodiment of the present invention;

FIG. 10 is a flow chart of a content modularization service in the transitions of screens on the Web in the system according to a preferred embodiment of the present invention;

FIG. 11 is a flow chart of an eight-unit coded text file producing service in the transitions of screens on the Web in the system according to a preferred embodiment of the present invention;

FIG. 12 is a flow chart of an S-JIS/EUC-JP codes interconverting service in the transitions of screens on the Web in the system according to a preferred embodiment of the present invention;

FIG. 13 is an explanatory view of a user authentication screen on the Web in the system according to a preferred embodiment of the present invention;

FIG. 14 is an explanatory view of a screen display of the content data storage service on the Web in the system according to a preferred embodiment of the present invention;

FIG. 15 is an explanatory view a screen display of the content producing service on the Web in the system according to a preferred embodiment of the present invention;

FIG. 16 is an explanatory view of another screen display of the content producing service on the Web in the system according to a preferred embodiment of the present invention;

FIG. 17 is an explanatory view of a screen display of the content reproducing service on the Web in the system according to a preferred embodiment of the present invention;

FIG. 18 is an explanatory view of another screen display of the content reproducing service on the Web in the system according to a preferred embodiment of the present invention;

FIG. 19 is an explanatory view of a screen display of the content checking service on the Web in the system according to a preferred embodiment of the present invention;

FIG. 20 is an explanatory view of another screen display of the content checking service on the Web in the system according to a preferred embodiment of the present invention;

FIG. 21 is an explanatory view of a screen display of the binary table file producing service on the Web in the system according to a preferred embodiment of the present invention;

FIG. 22 is an explanatory view of another screen display of the binary table file producing service on the Web in the system according to a preferred embodiment of the present invention;

FIG. 23 is an explanatory view of a screen display of the mono-medium checking service on the Web in the system according to a preferred embodiment of the present invention;

FIG. 24 is an explanatory view of another screen display of the mono-medium checking service on the Web in the system according to a preferred embodiment of the present invention;

FIG. 25 is an explanatory view of a screen display of the content modularization service on the Web in the system according to a preferred embodiment of the present invention;

FIG. 26 is an explanatory view of another screen display of the content modularization service on the Web in the system according to a preferred embodiment of the present invention;

FIG. 27 is an explanatory view of a screen display of the eight-unit coded text file producing service on the Web in the system according to a preferred embodiment of the present invention;

FIG. 28 is an explanatory view of another screen display of the eight-unit coded text file producing service on the Web in the system according to a preferred embodiment of the present invention;

FIG. 29 is an explanatory view of a screen display of the S-JIS/EUC-JP codes interconverting service on the Web in the system according to a preferred embodiment of the present invention;

FIG. 30 is an explanatory view of another screen display of the S-JIS/EUC-JP codes interconverting service on the Web in the system according to a preferred embodiment of the present invention;

FIG. 31 is a schematic diagram showing the whole of a digital data broadcasting program producing apparatus according to a second preferred embodiment of the present invention schematically;

FIG. 32 is a block diagram showing transitions of screens on the Web in the system according to a preferred embodiment of the present invention;

FIG. 33 is a block diagram showing the other transitions of screens on the Web in the system according to a preferred embodiment of the present invention;

FIG. 34 is a flow chart of a top service in the transitions of screens on the Web in the system according to a preferred embodiment of the present invention;

FIG. 35 is a flow chart of a template content providing service in the transitions of screens on the Web in the system according to a preferred embodiment of the present invention;

FIG. 36 is a flow chart of a mono-medium providing service in the transitions of screens on the Web in the system according to a preferred embodiment of the present invention;

FIG. 37 is an explanatory view of a screen display of the template content providing service on the Web in the system according to a preferred embodiment of the present invention;

FIG. 38 is an explanatory view of another screen display of the template content providing service on the Web in the system according to a preferred embodiment of the present invention;

FIG. 39 is an explanatory view of a screen display of the mono-medium providing service on the Web in the system according to a preferred embodiment of the present invention; and

FIG. 40 is an explanatory view of another screen display of the mono-medium providing service on the Web in the system according to a preferred embodiment of the present invention.

### DESCRIPTION OF THE PREFERRED EMBODIMENTS

In the following paragraphs, various embodiments of the digital data broadcasting program producing apparatus according to the present invention will be described by reference to the attached drawings.

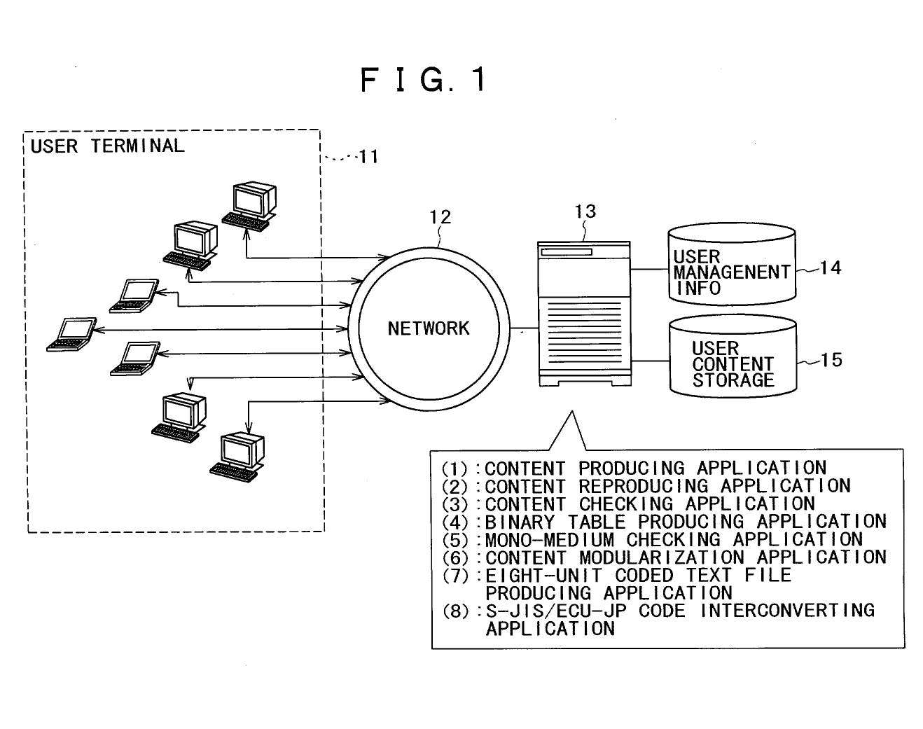

A digital data broadcasting program producing apparatus according to a first preferred embodiment of the present invention is, as shown in FIG. 1, roughly composed of client side connection terminals 11 as user terminals, and a Web server 13. The client side connection terminals 11 are composed of a plurality of connection terminals, which are connectable to each other through a network 12 such as the Internet and the like and are geographically distributed arbitrarily. The Web server 13 is connectable to the network 12 such as the Internet and the like, and thereby the Web server 13 is connectable to the client side connection terminals 11. Furthermore, the Web server 13 is equipped with software for producing content of a data broadcasting program.

The Web server 13 is provided with a user management information storage section 14 for storing user management information containing information on the client side connection terminals 11, and a user content storage section 15 for storing the content of data broadcasting programs produced by the client side connection terminals 11.

The user management information storage section 14 stores user identification (ID), passwords and the like for the client side connection terminals 11, and the user management information storage section 14 authenticates the client side connection terminals 11 on the basis of the user management information.

The user content storage section 15 receives and stores the content produced by the client side connection terminals 11 on the Web. When the content is produced in part for update, or partial replacement, the content stored in the user content storage section 15 is read out to produce the new content, etc.

In the above-mentioned Web server 13, various applications for producing the content of data broadcasting programs are prepared, such as (1) content producing application, (2) content reproducing application, (3) content checking application, (4) binary table file producing application, (5) mono-medium checking application, (6) content modularization application, (7) eight-unit coded text file producing application and (8) S-JIS/ECU-JP codes interconverting application.

It is to be noted that, these applications can be changed or updated whenever required, at any time. Moreover, it is needless to say that it is possible to improve the efficiency of the content production by introducing a new application.

The content of data broadcasting programs is produced on the Web by using such various applications and various tools.

The Web server 13 can provide services to all of the client side connection terminals 11 which can access the Internet and can be authenticated.

The services provided by the Web server 13 are ones such that a user can drive the above-mentioned various applications on the Web. In the present example of preferred embodiment of the present invention, the services are (1) a content data storage service, (2) a content producing service, (3) a content reproducing service, (4) a content checking service, (5) a binary table file producing service, (6) a mono-medium checking service, (7) a content modularization service, (8) an eight-unit coded text file producing service and (9) an S-JIS/EUC-JP codes interconverting service.

It becomes possible to use these services by accessing a TOP page of a home page, in which various services are available, on the Web server 13 to obtain authentication of a home page performing each of the services.

As described in the following description, each service is realized by performing the following processes.

(1) Content Data Storage Service

In the content data storage service, because an authentication screen is first displayed on a screen of a client side connection terminal 11, a user inputs his or her name and password. Then, when the input user name and the password match the information stored in the user management information storage section 14 of the Web server 13, folders and files which are opened to the designated user are made to be accessible, and the files or the folders are made to be freely readable and writable.

(2) Content Producing Service

In the content producing service, because an authentication screen is first displayed on a screen of a client side connection terminal 11, a user inputs his or her name and password. Then, when the input user name and the password match the client side information, which is stored in the user management information storage section 14 of the Web server 13, it becomes possible to use the content producing application on the Web.

(3) Content-Reproducing Service

In the content reproducing service, because an authentication screen is first displayed on a screen of a client side connection terminal 11, a user inputs his or her name and password. Then, when the input user name and the password match the client side information, which is stored in the user management information storage section 14 of the Web server 13, a file for reproducing the content of a data broadcasting program on the Web is designated.

After designating the file for reproducing the content, the user performs the start process of content reproduction. Thereby, the content reproducing application for reproducing the content on the Web is executed, and then the reproduction of desired content is started.

Here, by operating a remote control on the Web or a keyboard of a computer, a process similar to an operation of an actual remote control is executed, and it becomes possible to perform an operate, or a control, for reproducing the desired content.

(4) Content Checking Service

In the content checking service, because an authentication screen is first displayed on a screen of a client side connection terminal 11, a user inputs his or her name and password. Then, when the input user name and the password match the client side information, which is stored in the user management information storage section 14 of the Web server 13, a screen for designating the content to be checked on the Web and for designating (inputting) various pieces of checking reference information is displayed on the client side connection terminal 11.

After designating the content to be checked, the user performs a start operation of a content check process. Then, a check of the designated content is performed. The check of the content is performed to the following items of (1)-(3) on the basis of the standards regulated by the ARIB and checking reference information which a user of a service on the client side has arbitrarily set: (1) a validity check of the content in accordance with standards regulated by the ARIB and updated standards; (2) a check of character codes such as Shifted Japanese Industrial Standard (S-JIS), Extended UNIX(R) Code JP (ECU-JP) and the like; and (3) a check of external character codes described in the designated content.

Here, S JIS is widely disseminated as a standard character code for a personal computer and the like. Only an examination according to a first byte of a character of S-JIS makes it clear whether the character is a kanji ideogram or a one-byte character. S-JIS has the character in which the number of digits on a screen matches the number of bytes in case of an expression by the use of an equal width font. EUC JP is a character code for Japanese, which regulates a frame of a character code dealing with characters of a plurality of bytes to be used in UNIX(R) environment chiefly.

Results of the checks of the content are displayed on the screen of the client side connection terminal 11.

(5) Binary Table File Producing Service

In the binary table file producing service, an authentication screen is first displayed on a screen of a client side connection terminal 11, so that a user name and a password are input. Then, when the input user name and the password match the client side information, which is stored in the user management information storage section 14 of the Web server 13, a page is displayed on the screen of the client side connection terminal 11. In the page, an information file is designated for producing a binary table file on the Web, or inputs various pieces of information to be elements for the binary table file. In addition, the user designates a binary table format in the page.

After input and designation of these conditions on the screen, then production of the binary table file is started upon performing an operation of a starting table file producing process.

If a binary table format is designated on the screen of the client side connection terminal 11 at the time of producing the binary table, then the consistency of the designated binary table format with the various pieces of information in the binary table production is checked. If the designated binary table format does not match the various pieces of information, then the production of the binary table file is stopped, and the stop is made visible on the screen of the client side connection terminal 11. If the designated binary table format matches the various pieces of information, then the production of the binary table is performed.

Moreover, if any binary table format is not designated on the screen of the client side connection terminal 11 at the time of producing the binary table file, then a suitable binary table format is automatically produced on the basis of the various pieces of information at the time of producing the binary table file is produced. Then, the binary table file is produced in the automatically produced binary table format.

After the production of the binary table file, a page in which the produced binary table file is downloaded is displayed on the screen of the client side connection terminal 11 to provide the produced binary table file to a user of the service on the client side by downloading it. It is to be noted that, at such event, the binary table format of the produced binary table file is presented to the user of the service.

(6) Mono-Medium Checking Service

In the mono-medium checking service, an authentication screen is first displayed on a screen of a client side connection terminal 11, so that a user name and password are input. Then, when the input user name and the password match the client side information, which is stored in the user management information storage section 14 of the Web server 13, a page is displayed on the screen of the client side connection terminal 11. In the page, the type of mono-medium to be checked, the name of a file or a folder to be checked, and various pieces of check reference information on the Web are designated (input).

After designating the various pieces of information on the screen, a starting operation of a checking process of the mono-medium is carried out, thereby the check of the mono-media is started.

A mono-medium is an independent representation medium such as a picture, a static image, a graphic, audio content, a character and the like. The mono-medium can bulletin something only on the basis of its own data without referring to other media. Among the mono-media having such features, objects of the present example of preferred embodiment of the present invention are a moving picture in accordance with Moving Picture Experts Group 1 (MPEG-1), a moving picture in accordance with Moving Picture Experts Group 2 (MPEG-2), a frame picture in accordance with Moving Picture Experts Group 2 I (MPEG-2-I), and files concerning Joint Photographic Coding Experts Group (JPEG), Portable Network Graphics (PNG), Multiple Image Network Graphics (MNG), audio in accordance with MPEG-2 or Audio Interchange File Format-C (AIFF-C), and audio in accordance with Moving Picture Experts Group 4 (MPEG-4).

It is to be noted that, it is needless to say that the objects can appropriately be changed without being limited to these mono-media as targets.

The mono-medium check is performed on the basis of the standards regulated according to the ARIB and checking reference information set arbitrarily by the user of the service on the client side to the following items from 1 to 9.

1. MPEG-1 format moving picture file

2. MPEG-2 format moving picture file

3. MPEG-2-I frame format picture file

4. JPEG format picture file

5. PNG format picture file

6. MNG format picture file

7. MPEG-2 format audio file

8. Pulse Code Modulation (PCM) (AIFF-C) format audio file

9. MPEG-4 format audio file

And, after the completion of the checks of these mono-media, the results of the checks and the various pieces of information of the mono-media being the objects of the checks are displayed on the screen of the client side connection terminal 11.

(7) Content Modularization Service

In the content modularization service, because an authentication screen is first displayed on a screen of a client side connection terminal 11, a user inputs his or her name and password. Then, when the input user name and the password match the client side information, which is stored in the user management information storage section 14 of the Web server 13, a page is displayed on the screen of the client side connection terminal 11. In the page, a file group to be modularized on the Web can be designated (input), a folder in which files to be modularized reside, and various pieces of information to be necessary for performing the modularization.

After designating the various pieces of information on the screen, a starting operation of a modularized file producing process is performed. Thereby, the checks from the following items 1 and 2 are performed.

1. Check of content: the check is the same as the above-mentioned content checking service.

2. Check of mono-media: the check is the same as the above-mentioned mono-media checking service.

If an abnormality is detected as a result of these checks, then the detection is displayed on the screen of the client side connection terminal 11, and the modularized file producing process is stopped.

If no abnormality is detected in the checks, then the modularized file producing process is performed.

Then, after the modularized file has been produced, a page in which the produced modularized file is downloaded is displayed on the screen of the client side connection terminal 11. Then, the produced modularized file is provided by download to the user of the service on the client side.

(8) Eight-Unit Coded Text File Producing Service

In the eight-unit coded text file producing service, an authentication screen is first displayed on a screen of a client side connection terminal 11, so that a user name and password are input. Then, when the input user name and the password match the client side information, which is stored in the user management information storage section 14 of the Web server 13, a page is displayed on the screen of the client side connection terminal 11. In the page, a file of origin to be converted to an eight-unit coded text file is designated on the Web, or a text for producing a real eight-unit coded image is input.

After designating the various pieces of information on the screen of the client side connection terminal 11, a starting operation of an eight-unit coded text file producing process is performed. Thereby, the production of the eight-unit coded text file is started.

After the eight-unit coded text file has been produced, a page in which the produced eight-unit coded text file is downloaded is displayed on the screen of the client side connection terminal 11. Then, the produced eight-unit coded text file is provided by download to the user of the service on the client side.

(9) S-JIS/EUC-JP Codes Interconverting Service

In the S-JIS/EUC-JP codes interconverting service, because an authentication screen is first displayed on a screen of a client side connection terminal 11, a user inputs his or her name and password. Then, when the input user name and the password match the client side information, which is stored in the user management information storage section 14 of the Web server 13, a page is displayed on the screen of the client side connection terminal 11. In the page, a file having the character code converted on the Web is selected, and further a character code to which the original character code should be converted (the character code will hereinafter be referred to as a destination character code) is selected. After designating the various pieces of information on the screen of the client side connection terminal 11, a starting operation of a character code conversion process is performed. Thereby, the designated file is converted to the designated character code. It is to be noted that, if no destination character code has been designated on the screen of the client side connection terminal 11, then the character code of the file to be converted is automatically surveyed, and the character code of the file to be converted is converted to a character code to form a pair with the character code of the file to be converted.

At the time of a conversion of character codes, a check process equal to the above-mentioned (4) content checking service is performed.

If an abnormality is detected in the content check, then the detection is displayed on the screen of the client side connection terminal 11, and the character code conversion process is stopped.

If no abnormality is detected in the above-mentioned content check, then the character code conversion process is performed.

After the completion of the production of a file after the character code conversion, a page in which the produced file is downloaded is displayed on the screen of the client side connection terminal 11. Then, the produced file is provided by download to the user of the service which is a client.

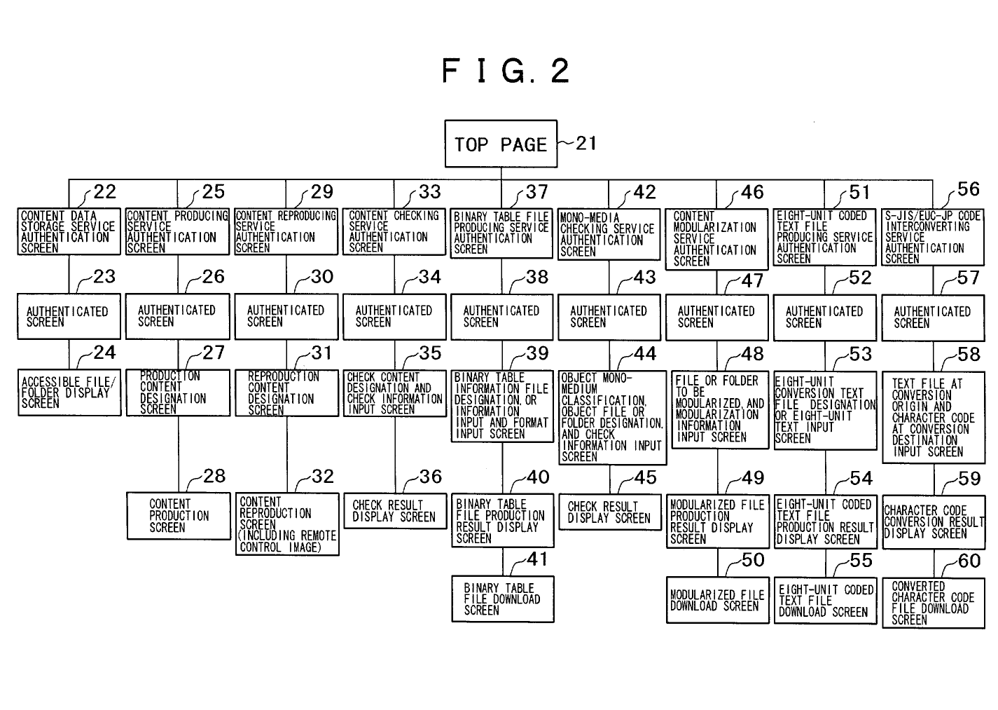

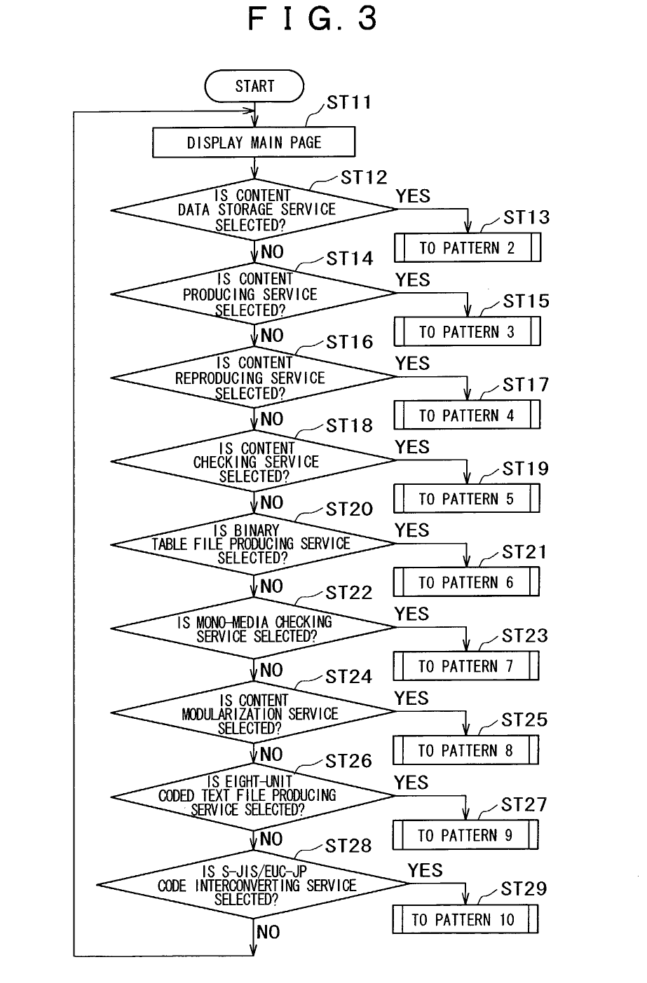

The operation of the digital data broadcasting program producing apparatus capable of performing such various services will be described in the following by reference to FIG. 1 based on FIG. 2 and the flow charts of FIG. 3 to FIG. 12. It is to be noted that, as described above, the present system is made to be capable of displaying various pages necessary for the content of a data broadcasting program on a screen of a client side connection terminal 11. Then, a user selects and designates, or inputs, desired information in the pages. Thereby, the content of the data broadcasting program is produced.

First, as shown in FIG. 2, in various display screens to be displayed on a screen of a client side connection terminal 11, lower hierarchical display screens are gradually displayed in conformity with instructions on the displayed screen hierarchically by selection of nine head display screens in a TOP page 21, and then the content of a data broadcasting program is produced by performing the operations such as selection, designation, inputting and the like of information.

The head display screens selectable in the TOP page 21 are composed of a “content data storage service authentication screen” 22, a “content producing service authentication screen” 25, a “content reproducing service authentication screen” 29, a “content checking service authentication screen” 33, a “binary table file producing service authentication screen” 37, a “mono-media checking service authentication screen” 42, a “content modularization service authentication screen” 46, an “eight-unit coded text file producing service authentication screen” 51 and an “S-JIS/EUC-JP character codes interconverting service authentication screen” 56. In the following, their operations will be described in order when they are selected.

When the “content data storage service authentication screen” 22 is selected, an “authenticated screen” 23 and an “accessible file/folder display screen” 24 follow as its low order screens.

When the “content producing service authentication screen” 25 is selected, an “authenticated screen” 26, a “production content designation screen” 27 and a “content production screen” 28 follow as its low order screens.

When the “content reproducing service authentication screen” 29 is selected, an “authenticated screen” 30, a “reproduction content designation screen” 31 and a “content reproduction screen” 32 (including a remote control image) follow as its low order screens.

When the “content checking service authentication screen” 33 is selected, an “authenticated screen” 34, a “check content designation and check information input screen” 35 and a “check result display screen” 36 follow as its low order screens.

When the “binary table file producing service authentication screen” 37 is selected, an “authenticated screen” 38, a “binary table information file designation, or information input and format input screen” 39, a “binary table file production result display screen” 40 and a “binary table file download screen” 41 follow as its low order screens.

When the “mono-media checking service authentication screen” 42 is selected, an “authenticated screen” 43, an “object mono-medium classification, object file or folder designation, and check information input screen” 44 and a “check result display screen” 45 follow its low order screens.

When the “content modularization service authentication screen” 46 is selected, an “authenticated screen” 47, a “file or folder to be modularized, and modularization information input screen” 48, a “modularized file production result display screen” 49 and a “modularized file download screen” 50 follow as its low order screens.

When the “eight-unit coded text file producing service authentication screen” 51 is selected, an “authenticated screen” 52, an “eight-unit conversion text file designation or eight-unit coded text input screen” 53, an “eight-unit coded text file production result display screen” 54 and an “eight-unit coded text file download screen” 55 follow as its low order screens.

When the “S-JIS/EUC-JP codes interconverting service authentication screen” 56 is selected, an “authenticated screen” 57, a “text file at conversion origin and character code at conversion destination input screen” 58, a “character code conversion result-display screen” 59 and a “converted character code file download screen” 60 follow as its low order screens.

As described above, the desired content can be produced by the appropriate selection of screens for generating material data to produce content displayed in the TOP page 21.

The digital data broadcasting program producing apparatus for producing specific content will be described on the basis of the flow chart of FIG. 3 by reference to FIGS. 1 and 2.

First, when the “content data storage service authentication screen” 22 is selected from the TOP page 21 shown in FIG. 2, the process of the digital data broadcasting program producing apparatus proceeds to the content data storage service routine of a pattern 2, in steps ST11, ST12 and ST13.

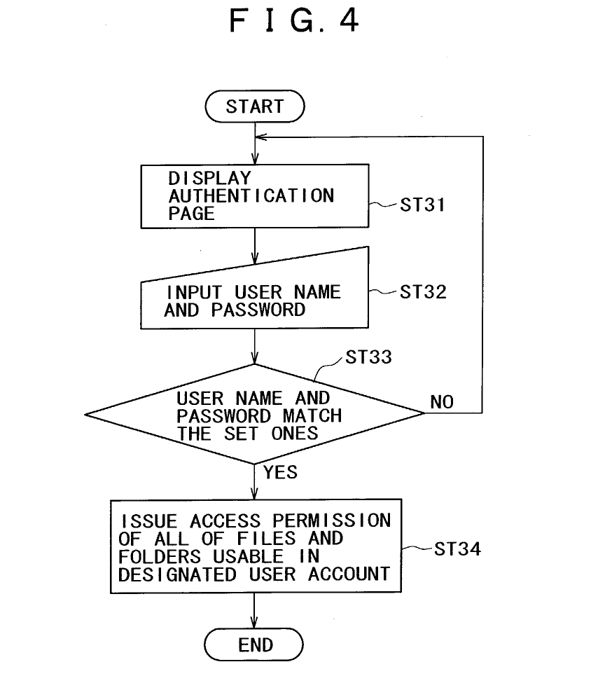

In the content data storage service routine, as shown in FIG. 4, a display screen of an authentication page is first displayed, in step ST31.

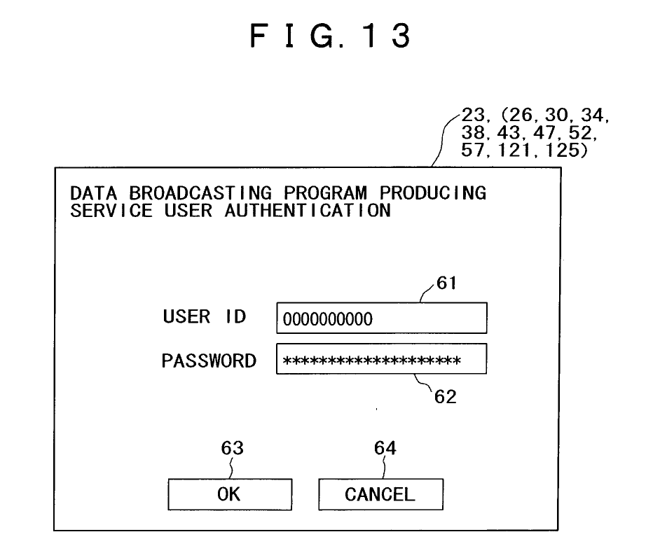

In the authentication screen, as shown in FIG. 13, the title of “DATA BROADCASTING PROGRAM PRODUCING SERVICE USER AUTHENTICATION” is displayed, and an input icons of user ID 61, a password 62, an OK key 63 and a cancel key 64 are displayed in a view.

Back to FIG. 4, a user inputs his or her user ID and password into such an authentication screen, in step ST32. When the input user ID and the password do not match the previously set user ID and password, another user ID and another password are input, in step ST33.

When the input user ID and the password match the previously set user ID and the password, instep ST33, access permission to all of the files and the folders which are usable in the designated user account is issued, in step ST34.

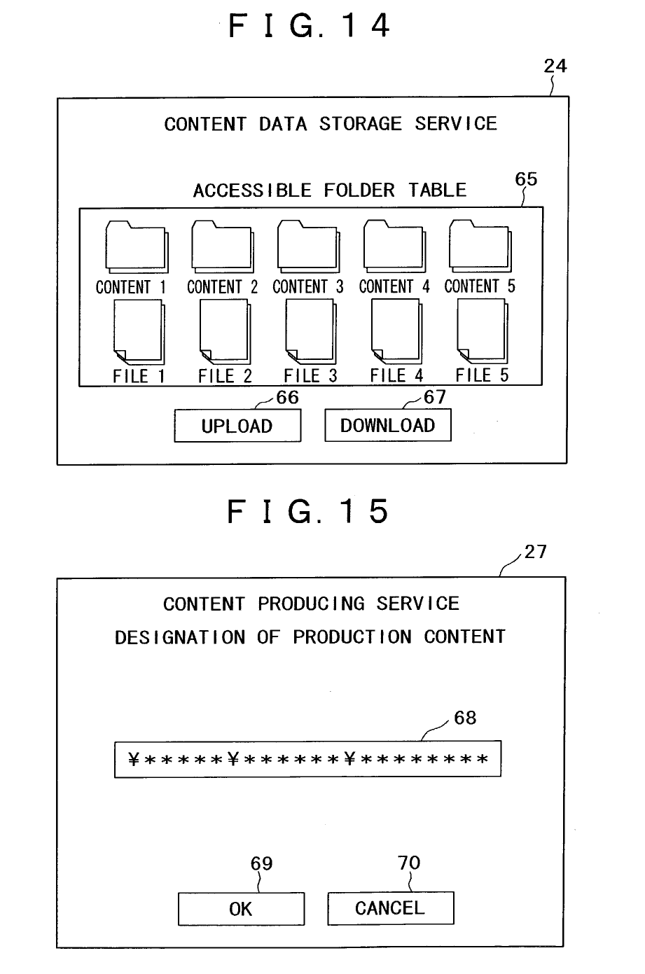

More specifically, as shown in FIG. 14, an accessible folder table 65 is displayed on a screen (the accessible file/folder display screen 24 shown in FIG. 2). In the present example of preferred embodiment of the present invention, content 1-5 and files 1 5 are displayed. Moreover, any one of the content 1-5 and the files 1-5 can be uploaded or downloaded by designating the one and by clicking an upload key 66 or a download key 67.

Back to FIG. 3, if the content data storage service is not selected at the step ST12, and if a content producing service is selected next, then the process of the digital data broadcasting program producing apparatus proceeds to the content producing service routine of a pattern 3, in steps ST14 and ST15.

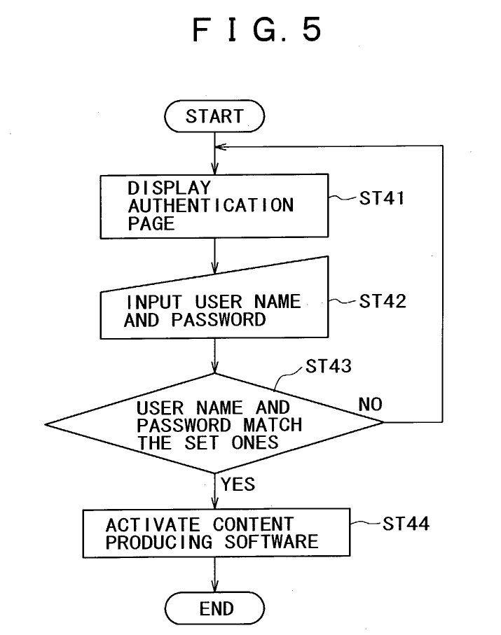

In the content producing service routine, as shown in FIG. 5, a display screen of an authentication page is first displayed, in step ST41.

The display screen of the authentication page is the above-mentioned screen shown in FIG. 13, and is configured to input the user ID 61 and the password 62.

Then, after the user ID 61 and the password 62 have been input, it is checked whether the input user ID 61 and the password 62 match previously set data or not, in steps ST42 and ST43. When they respectively match, the content producing application is activated, in step ST44.

When the content producing application is activated, a screen as shown in FIG. 15 is displayed. In the screen, the title of “CONTENT PRODUCING SERVICE” is displayed, and a production content designation screen (the production content designation screen 27 shown in FIG. 2) in which data 68 for designating production content is input is displayed. If the input data is normal, then an OK key 69 is clicked (activated), and if the input data is not normal, then a cancel key 70 is clicked.

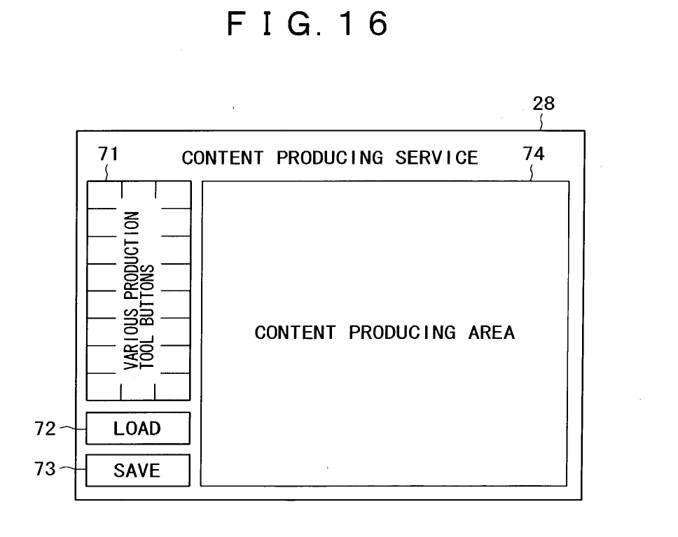

In addition, after the designation of production content, a content production screen (the content production screen 28 shown in FIG. 2) shown in FIG. 16 is displayed. The screen display is composed of various production tool buttons 71 and the screen of a content producing area 74. By clicking a load key 72, and a save key 73, desired data can be loaded or saved.

Back to FIG. 3, if the content producing service is not selected at the step ST14, then the selection of a content reproducing service is next examined. If the content reproducing service is selected, then the process of the digital data broadcasting program producing apparatus proceeds to the content reproducing service routine of a pattern 4, in steps ST16 and ST17.

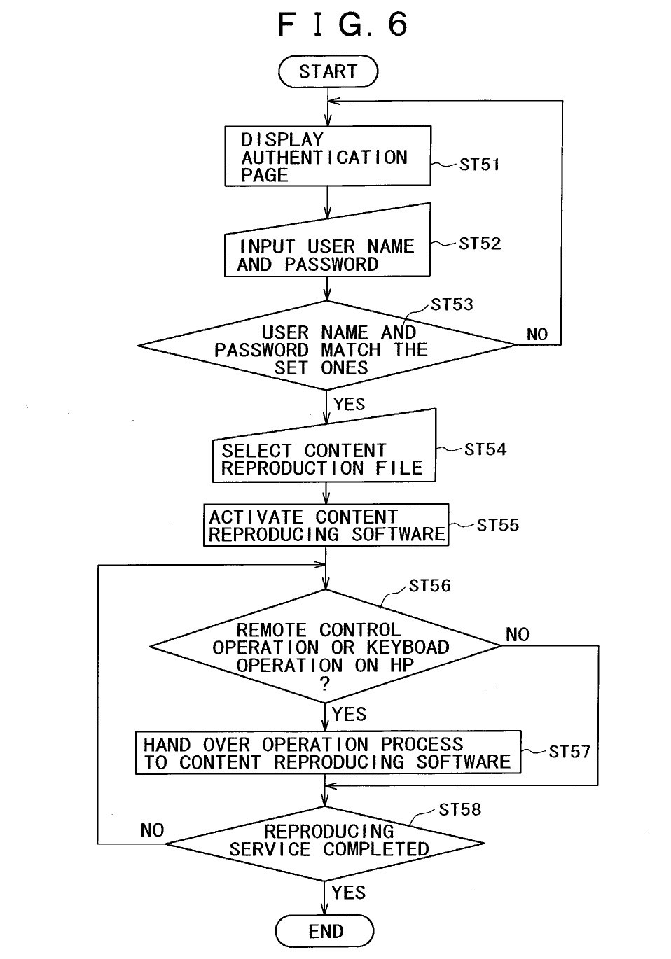

In the content reproducing service routine, as shown in FIG. 6, a display screen of an authentication page is first displayed, in step ST51.

The display screen of the authentication page is the above-mentioned screen shown in FIG. 13, and is configured to input the user ID 61 and the password 62.

Then, after the user ID 61 and the password 62 have been input, it is checked whether the input user ID 61 and the password 62 match previously set data or not, in steps ST52 and ST53. When they respectively match, a content reproduction file is selected, in step ST54.

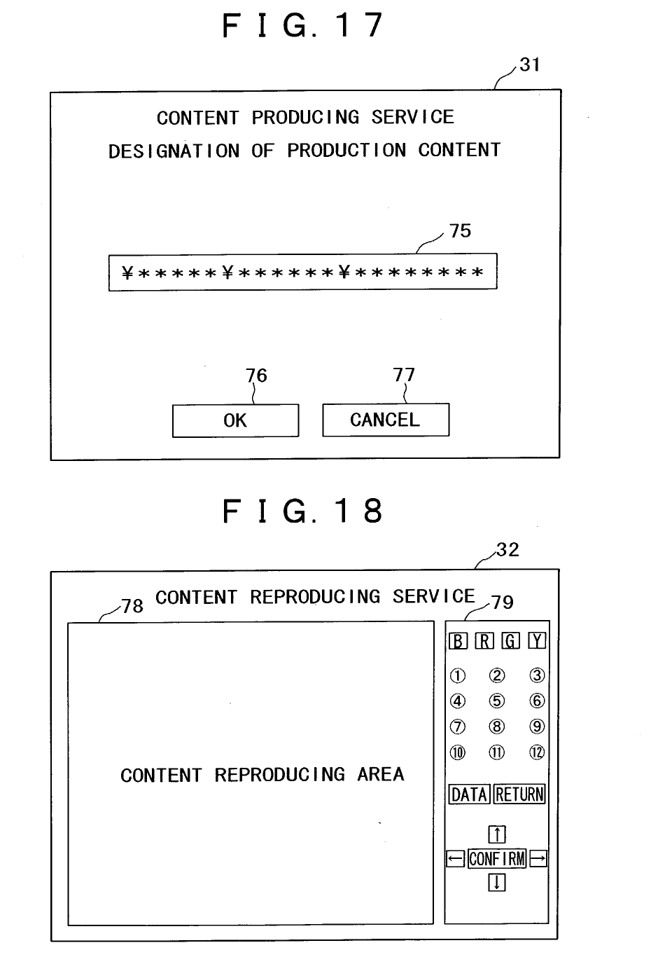

The selection of the content reproduction file is performed in a reproduction content designation screen (the reproduction content designation screen 31 shown in FIG. 2). As shown in FIG. 17, the title of “CONTENT REPRODUCING SERVICE” is displayed, and inputting 75 for designating reproduction content is executed. Then, an OK key 76 or a cancel key 77 is clicked to designate the content to be reproduced.

Next, back to FIG. 6, after the designation of the content to be reproduced, the content reproducing application is activated, in step ST55.

When the content reproducing application is activated, a content reproduction screen (the content reproduction screen 32 shown in FIG. 2) shown in FIG. 18 is displayed, and a content reproducing area 78 and a remote control image screen 79 are displayed therein. By a remote control operation in a Web page or by a keyboard operation of a computer, the same processes as ones owing to an actual remote control are executed, and thereby it becomes possible to operate (control) content.

That is, when a remote control operation or a keyboard operation is performed on a home page at step ST56, a process coping with the operation is handed over to the content reproducing application, and the content reproducing process is executed in conformity with the content reproducing application. Until the reproduction service has been completed therein, remote control operations and keyboard operations are performed, in steps ST57 and ST58.

Back to FIG. 3, if the content reproducing service is not selected at the step ST16, then the selection of the content checking service is next examined. If the content checking service is selected, then the process of the digital data broadcasting program producing apparatus proceeds to the content checking service routine of a pattern 5, in steps ST18 and ST19.

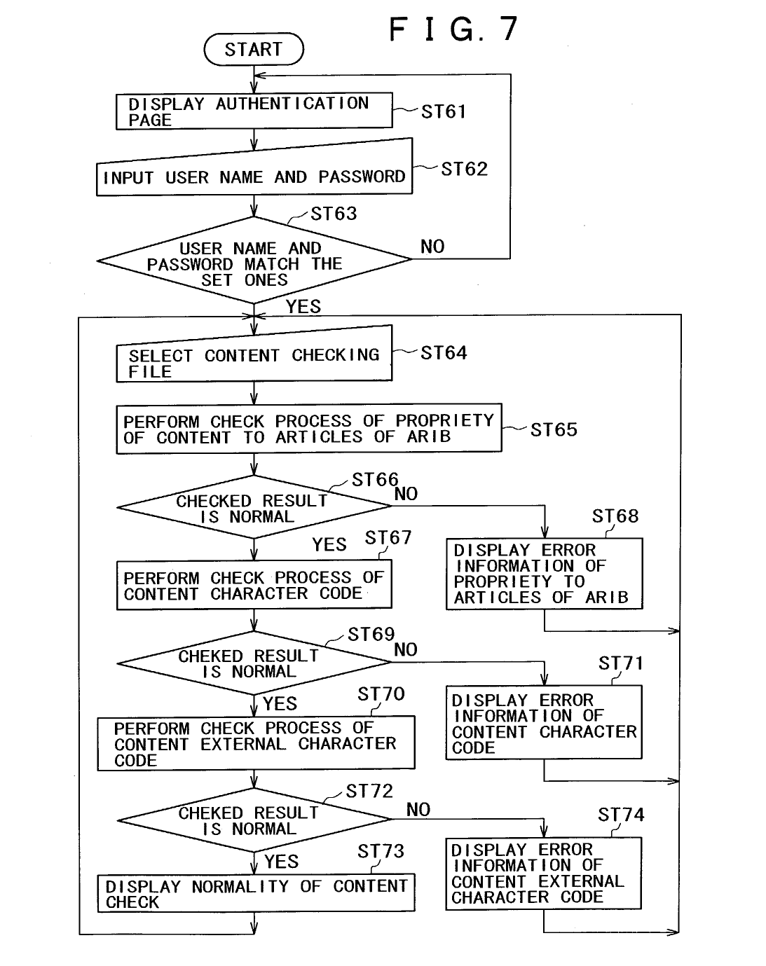

In the content checking service routine, as shown in FIG. 7, a display screen of an authentication page is first displayed, in step ST61.

The display screen of the authentication page is the above-mentioned “authenticated screen” 34 shown in FIG. 13, and is configured to input the user ID 61 and the password 62.

Then, after the user ID 61 and the password 62 have been input, it is checked whether the input user ID 61 and the password 62 match the previously set data or not in steps ST62 and ST63. When they respectively match, a content checking file is selected, in step ST64.

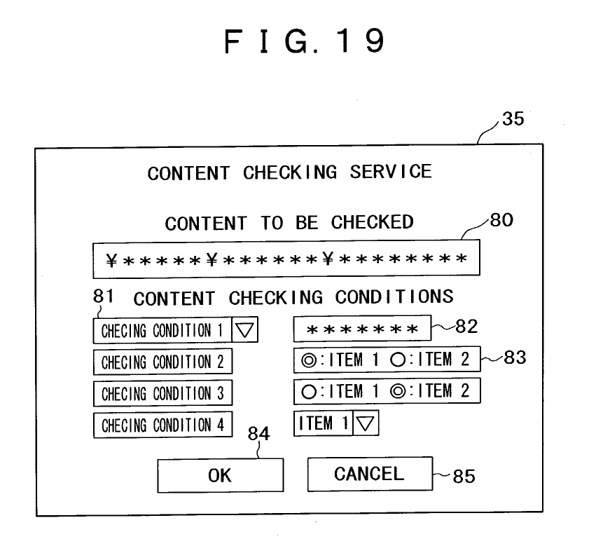

The selection of the content checking file is performed in the “check content designation and check information input screen” 35 shown in FIG. 2. The “check content designation and check information input screen” 35 displays the title of “CONTENT CHECKING SERVICE” as shown in FIG. 19, and the selection of the content checking file is performed by the input of content to be checked 80 and by the input of content checking conditions 81, 82 and 83. Then, an OK key 83 or a cancel key 85 is clicked when the input content and conditions 80-83 are OK or NG, respectively.

Here, the checking process is performed for the validity of content to the standards regulated by the ARIB, in steps ST65 and ST66.

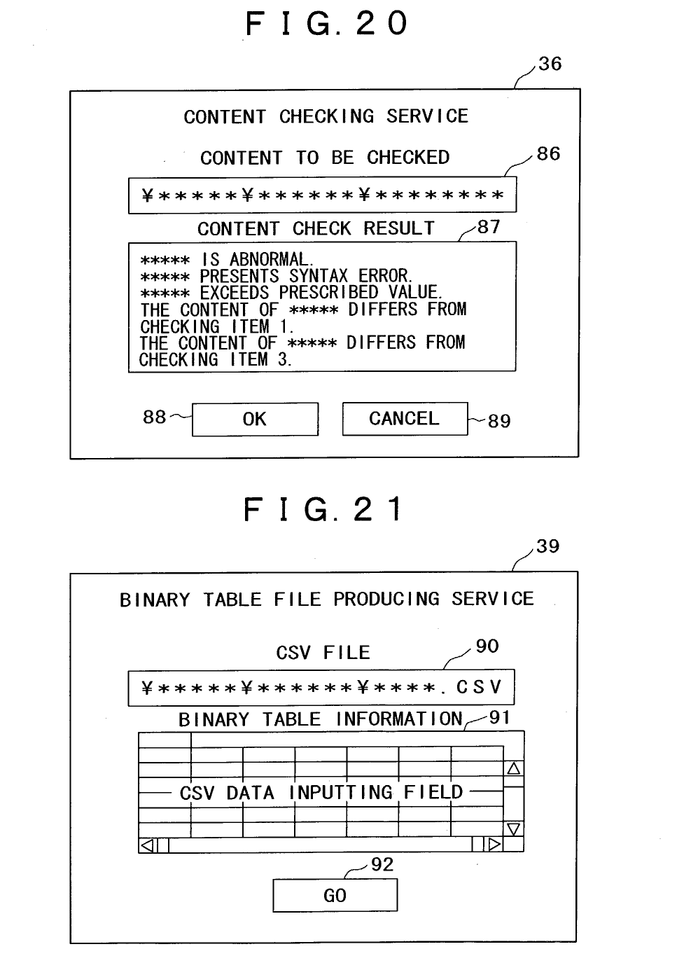

If the result of the checking is not successful, then a check result display screen (the check result display screen 36 shown in FIG. 2) shown in FIG. 20 is displayed. In addition, content to be checked 86 and validity error information, which is the content check result 87, to the standards regulated by the ARIB are displayed, in step ST68. Then, after a strike of an OK key 88 or a cancel key 89 according to being OK or NG, respectively, the process of the digital data broadcasting program producing apparatus returns to the step ST64, and a content checking file is selected again.

If the check result at a step ST66 is normal, then a check process of a content character code is performed, in steps ST67 and ST69.

If the result of the check is not normal, then the check result display screen (the check result display screen 36 shown in FIG. 2) shown in FIG. 20 is displayed, and content to be checked 86 and content external character code error information as the content check result 87 are displayed, in step ST74. Then, after clicking the OK key 88 or the cancel key 89 according to being OK or NG, respectively, the process of the digital data broadcasting program producing apparatus returns to the step ST64, and a content checking file is selected again.

If the result of the checking is successful at the step ST72, then a display indicating the content check being successful is performed. Then, the process of the digital data broadcasting program producing apparatus returns to the step ST64, and a content checking file is selected again.

Back to FIG. 3, if the content checking service is not selected at the step ST18, then it is checked whether the binary table file producing service is selected or not, in step ST20. If the binary table file producing service is selected, then the process of the digital data broadcasting program producing apparatus advances to the binary table file producing service routine of a pattern 6, in step ST19.

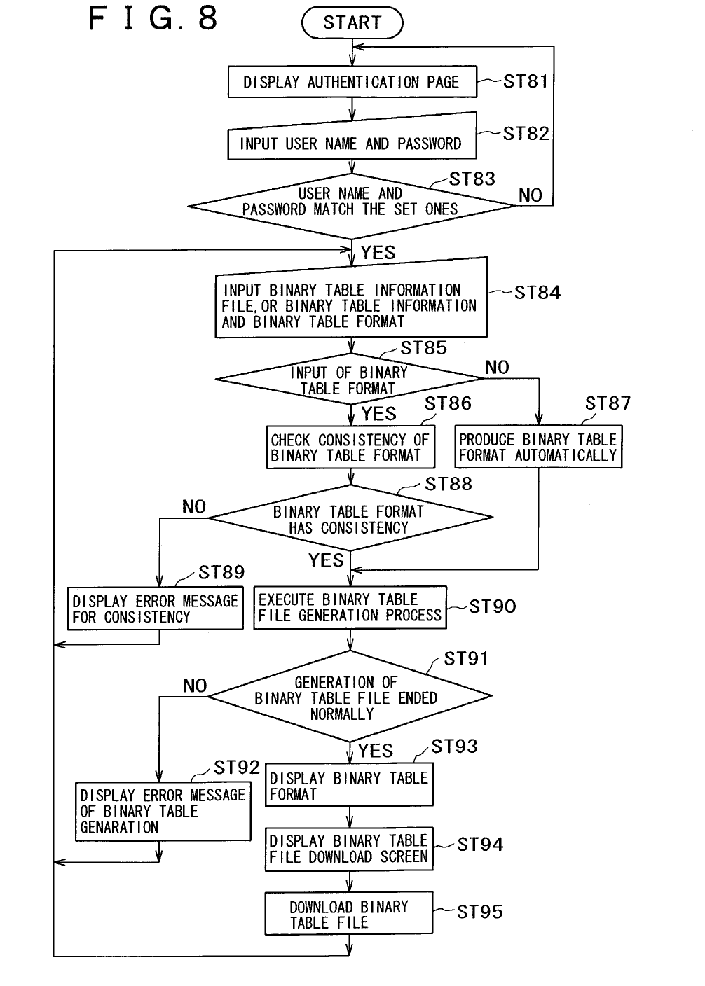

In the binary table file producing service routine, as shown in FIG. 8, a display screen of an authentication page is first displayed, in step ST81.

The display screen of the authentication page is the above-mentioned screen shown in FIG. 13 (the authenticated screen 38 shown in FIG. 2), and is configured to input the user ID 61 and the password 62.

Then, after the user ID 61 and the password 62 have been input, it is checked whether the input user ID 61 and the password 62 match previously set data or not, in steps ST82 and ST83. When they match respectively, a binary table information file, or binary table information and a binary format, are input, in step ST84.

At this input, a file name 90 and binary table information to be input into an inputting field 91 are input into a screen shown in FIG. 21 (the binary table information file designation, or information input and format input screen 39 in FIG. 2), and finally a production key 92 is clicked when the production is completed.

Then, the production of a binary table file is started. If a binary table format is designated, then the consistency of the binary table format with various pieces of information in the binary table production is checked, in steps ST85 and ST86.

If no binary table format is designated at the step ST85, then a binary table format is automatically produced, in step ST87.

If a result of the check of the binary table format consistency at step ST86 indicates that the binary table format does not have the consistency with the information, then a consistency error message is displayed, and the process of the digital data broadcasting program producing apparatus returns to the step ST84, in steps ST88 and ST89. Then, inputting is again performed.

If the binary table format is judged to have the consistency with the information at the step ST88, then a binary table file generation process is performed, step ST90.

Moreover, if the generation of the binary table file has not end successfully, then a binary table file generation error message is displayed. Then, the process of the digital data broadcasting program producing apparatus returns to the step ST84, and the inputting of a format is performed again, in steps ST91 and ST92.

If a binary table file has been generated successfully at the step ST91, then its binary table format is displayed, and a screen for downloading the binary table file is displayed. And then, the binary table file is actually downloaded, in steps ST93, ST94 and ST95.

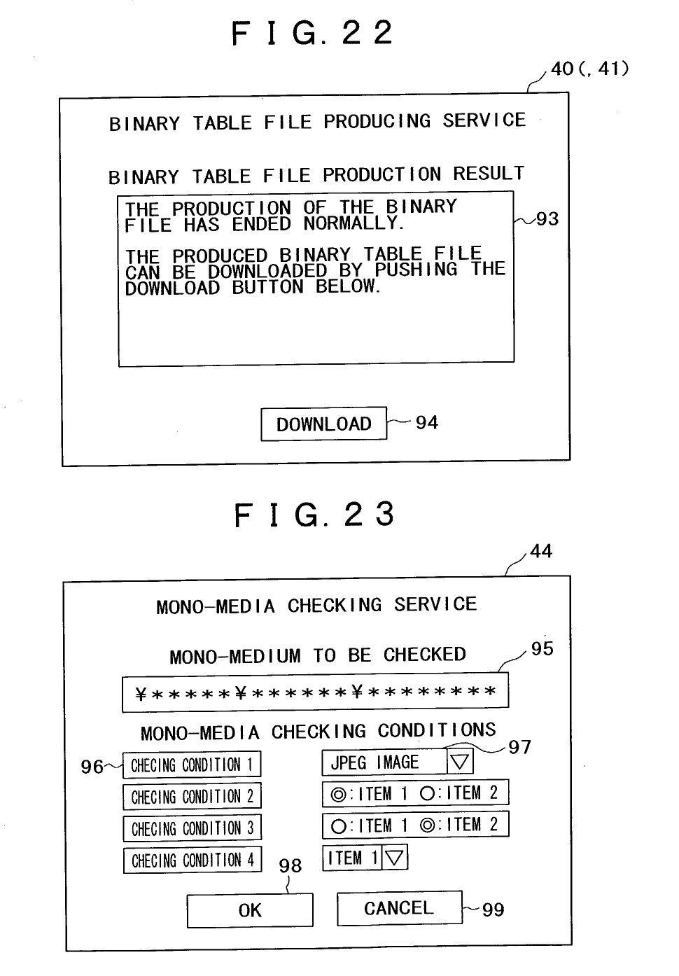

In the display screen, as shown in FIG. 22, a binary table file production result screen (the binary table file production result display screen 40 and binary table file download screen 41 in FIG. 2) is displayed, and the title of “BINARY TABLE FILE PRODUCING SERVICE” is displayed. Next, for example, a binary table file production result 93 and a download key 94 are displayed. In case of downloading, a produced binary table file can be downloaded by clicking the download key 94.

In FIG. 3 again, if the binary table file producing service is not selected at the step ST20, then it is checked next whether a mono-media checking service is selected or not, in step ST22. If the mono-media checking service is selected, then the process of the digital data broadcasting program producing apparatus proceeds to the mono-media checking service routine of a pattern 7, in step ST23.

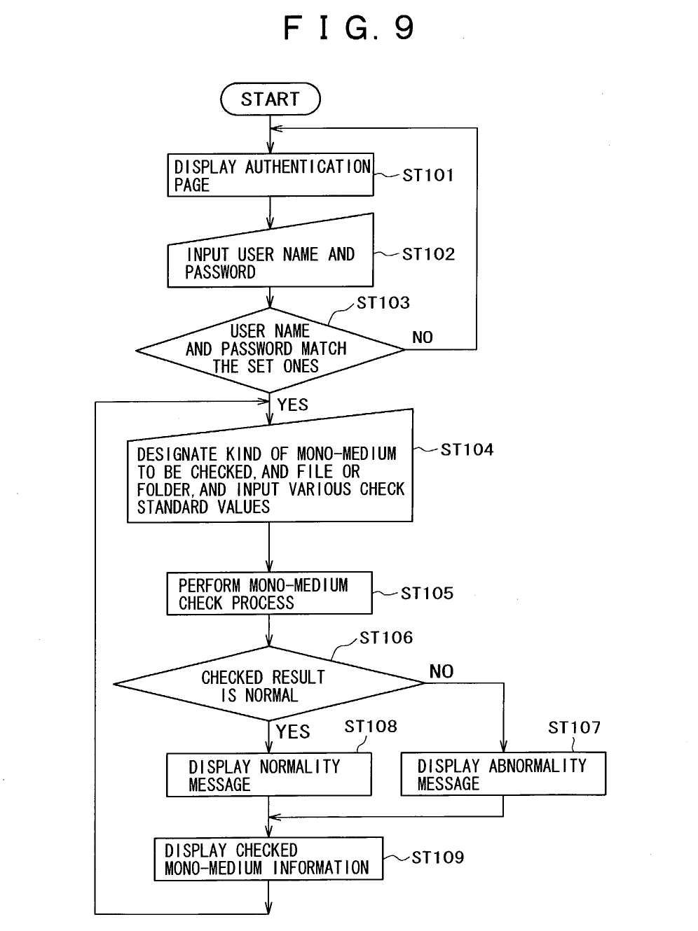

In the mono-media checking service routine, as shown in FIG. 9, a display screen of an authentication page is first displayed, in step ST101.

The display screen of the authentication page is the above-mentioned screen shown in FIG. 13 (the authenticated screen 43 shown in FIG. 2), and is configured to input the user ID 61 and the password 62.

Then, after the user ID 61 and the password 62 have been input, it is checked whether the input user ID 61 and the password 62 match previously set data or not, in steps ST102 and ST103. When they respectively match, the type of mono-medium to be checked, and a file or a folder are designated, and various check standard values are input, in step ST104.

At this input, an input screen shown in FIG. 23 (the object mono-medium classification, object file or folder designation, and check information input screen 44 shown in FIG. 2) is displayed, and the title of “MONO-MEDIA CHECKING SERVICE” is displayed. A mono-medium to be checked 95 and mono-media checking conditions 96 and 97 are input next, and an OK key 98 or a cancel key 99 is clicked according to an input being OK or an input being NG, respectively.

When the input has been completed, a mono-medium checking process is performed. If a check result is not successful, then an abnormality message of the check is displayed, in steps ST105, ST106 and ST107.

If a check result is judged to be successful at the step ST106, then a check normality message is displayed, and checked mono-medium information is displayed. Thus, a series of the processes of the routine ends. Then, the process of the digital data broadcasting program producing apparatus returns to the step ST104 again, and an input operation concerning mono-media is performed, in steps ST108 and ST109.

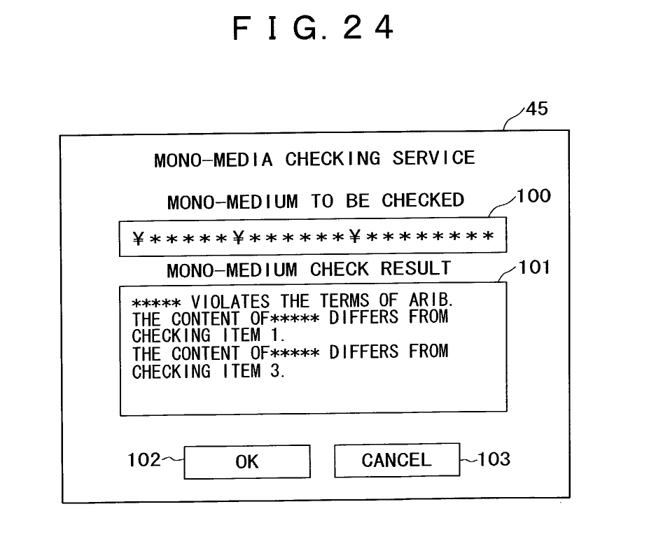

In the input screen (the check result display screen 45 in FIG. 2), as shown in FIG. 24, a mono-medium to be checked 100 and a mono-medium check result 101 are displayed. If the mono-medium check result 101 is OK, then an OK key 102 is clicked, and if the check is cancelled, then a cancel key 103 is clicked.

Now, the mono-medium check result 101 is displayed in a way such as “*** violates the standards of the ARIB.”, “The content of the *** differs from checking item 1.”, and “The content of the *** differs from checking item 3.”.

Back to FIG. 3, if the mono-media checking service is not selected at the step ST22, and then, if the content modularization service is selected, then the process of the digital data broadcasting program producing apparatus proceeds to the routine of the content modularization service of a pattern 8, in steps ST24 and ST25.

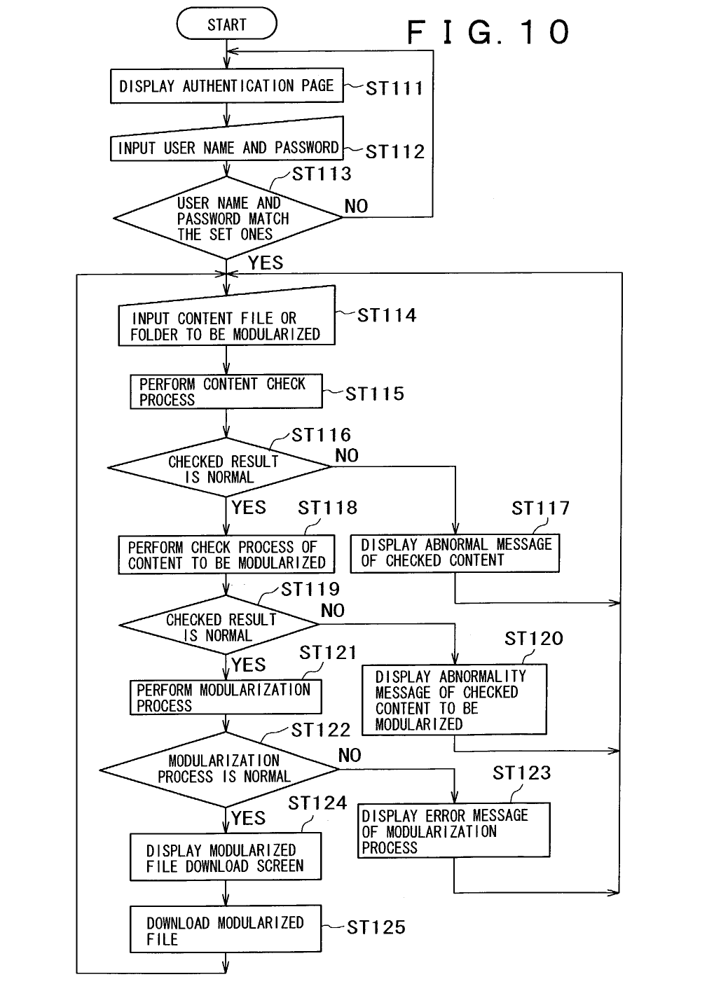

In the routine of the content modularization service, as shown in FIG. 10, a display screen of an authentication page is first displayed, step ST111.

The display screen of the authentication page is the above-mentioned screen shown in FIG. 13 (the authenticated screen 47 shown-in FIG. 2), and is configured to input the user ID 61 and the password 62.

Then, after the user ID 61 and the password 62 have been input, it is checked whether the input user ID 61 and the password 62 match previously set data or not, in steps ST112 and ST113. When they match respectively, the content file or folder to be modularized is input, in step ST114.

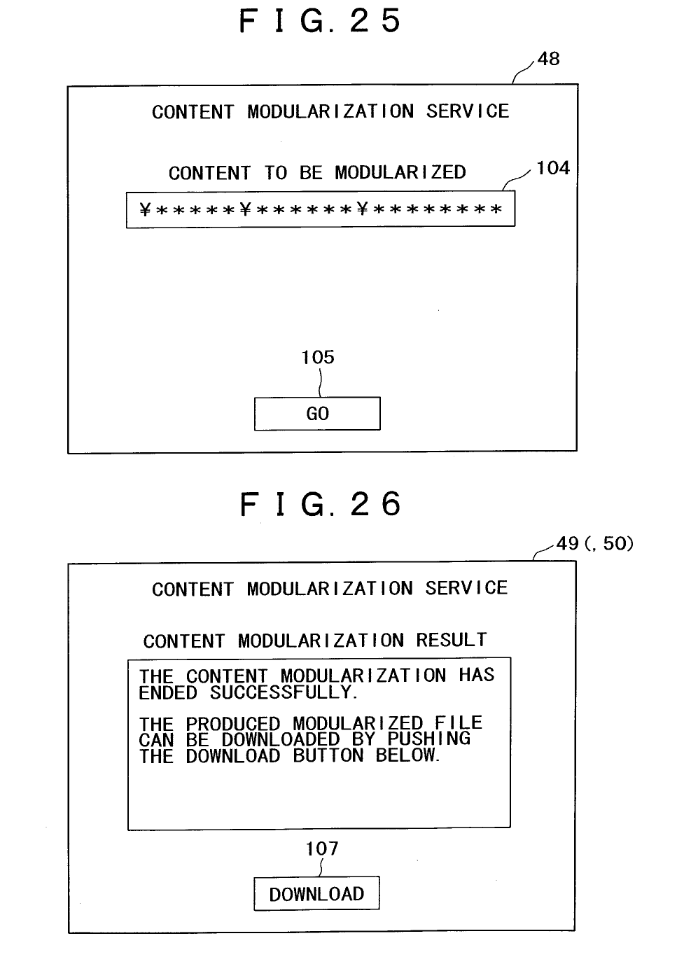

At the input of the content file or folder to be modularized, an input screen shown in FIG. 25 (the file or folder to be modularized, and modularization information input screen 48 shown in FIG. 2) is displayed, and content to be modularized 104 is input. If the modularization of the content is OK, then a production key 105 is clicked.

When the input ends, a content check process is next performed, in step ST115.

If a result of the content check process indicates abnormality, then an abnormality message of the checked content is displayed, and the process of the digital data broadcasting program producing apparatus returns to the step ST114, in steps ST116 and ST117. Then, inputting is performed again.

If a result of the check at the step ST116 indicates normality, then a check process of the content to be modularized is performed, in step ST118.

If the content to be modularized is judged to be abnormal at the check process, then an abnormality message of the checked content to be modularized is displayed, in steps ST119 and ST120. Then, the process of the digital data broadcasting program producing apparatus returns to the step ST114, and an input operation is again performed.

If a check result at the step ST119 indicates normality, then a modularization process is performed, in step ST121.

Then, if the modularization process is not successful, then an error message of the modularization process is displayed, in steps ST122 and ST123. And, the process of the digital data broadcasting program producing apparatus returns to the step ST114, and an input operation is again performed.

If the modularization process is successfully performed at the step ST122, then a modularized file download screen is displayed, and a modularized file is downloaded, in steps ST124 and ST125. Then, the process of the digital data broadcasting program producing apparatus returns to the step ST114, and an input operation is again performed.

In the screen in which the results of the modularization process are displayed and in the screen in which the modularized file is downloaded (the modularized file production result display screen 49 and the modularized file download screen 50 in FIG. 2), as shown in FIG. 26, the title of “CONTENT MODULARIZATION SERVICE” is displayed. Moreover, a content modularization result 106 and a download key 107 for downloading modularized content are displayed. It is enough to click the download key 107 for downloading. Moreover, as the content modularization result 106, for example, notifications such as “The content modularization has ended successfully.”, “The produced modularized file can be downloaded by pushing the download button below.”, and the like are displayed.

back to FIG. 3, if the content modularization service is not selected at the step ST24, then it is next examined whether the eight-unit coded text file producing service is selected or not if the eight-unit coded text file producing service is selected, then the process of the digital data broadcasting program producing apparatus proceeds to the routine of the eight-unit coded text file producing service of a pattern 9, in steps ST26 and ST27.

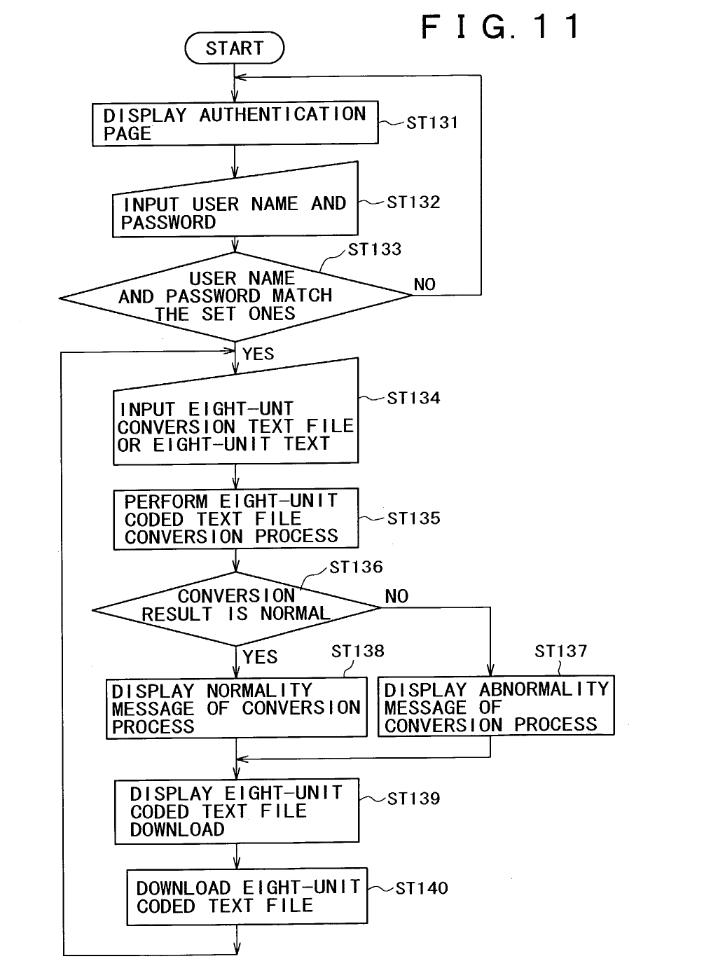

In the routine of the eight-unit coded text file producing service, as shown in FIG. 11, a display screen of an authentication page is first displayed, in step ST131.

The display screen of the authentication page is the above-mentioned screen shown in FIG. 13 (the authenticated screen 52 shown in FIG. 2), and is configured to input the user ID 61 and the password 62.

Then, after the user ID 61 and the password 62 have been input, it is checked whether the input user ID 61 and the password 62 match previously set data or not, in steps ST132 and ST133. When they respectively match, an eight-unit conversion text file or an eight-unit text is inputted, in step ST134.

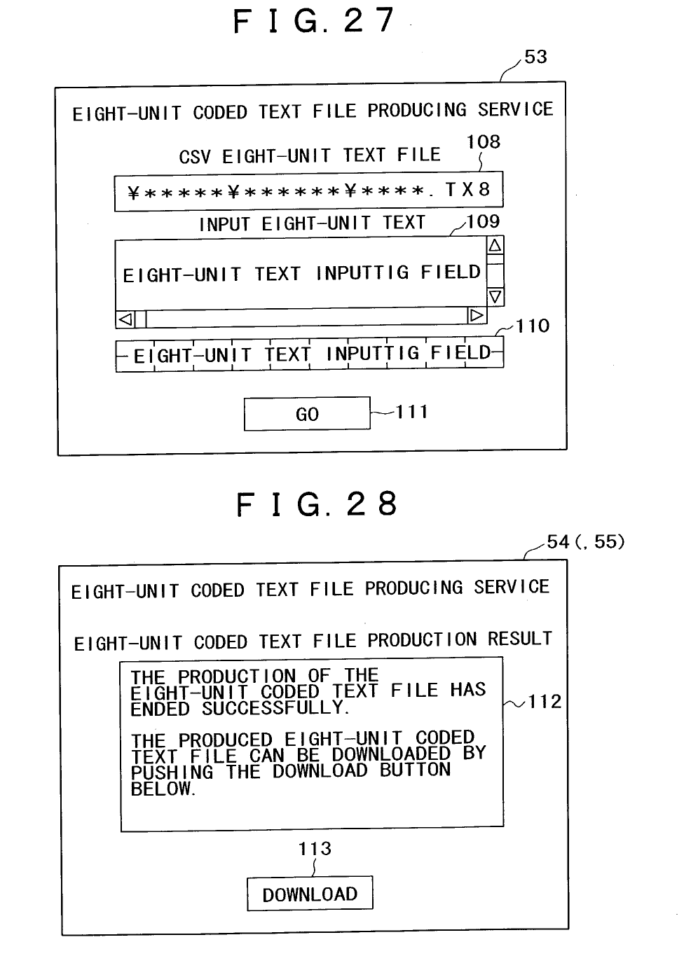

At this input, an input screen shown in FIG. 27 (the eight-unit conversion text file designation or eight-unit text input screen 53 in FIG. 2) is displayed, and the title of “EIGHT-UNIT CODED TEXT FILE PRODUCING SERVICE” is displayed. An icon of inputting comma separated value (CSV) eight-unit text file 108 and eight-unit text inputting fields 109 and 110 are next displayed. If inputs are appropriately performed and a production key 111 is clicked, then the eight-unit conversion text file or the eight-unit text can be input. The CSV indicates a feeder format in which data are arranged with commas (“,”) interposed between them.

When the input has been completed, an eight-unit coded text file conversion process is performed. If a conversion result is not successful, then an abnormality message of the conversion process is displayed, in steps ST135, ST136 and ST137.

If a conversion result is judged to be successful at the step ST136, then a normality message of the conversion process is displayed, and an eight-unit coded text file download screen is displayed, in steps ST138 and ST139. If download is selected, then the eight-unit coded text file is downloaded, in step ST140. Then, the process of the digital data broadcasting program producing apparatus returns to the step ST134, and an input operation is again performed.

In the input screens (the eight-unit coded text file production result display screen 54 and the eight-unit coded text file download screen 55 in FIG. 2), as shown in FIG. 28, an eight-unit coded text file production result 112 and a download key 113 are displayed.

Now, the eight-unit coded text file production result 112 is displayed in a way such as “The production of the eight-unit coded text file has ended successfully.”, “The produced eight-unit coded text file can be downloaded by pushing the download button below.”, and the like.

Then, if the download key 113 is clicked, then the eight-unit coded text file can be downloaded.

Back to FIG. 3, if the eight-unit coded text file producing service is not selected at the step ST26, and then, if the S-JIS/EUC-JP codes interconverting service is selected, then the process of the digital data broadcasting program producing apparatus proceeds to the routine of the S-JIS/EUC-JP codes interconverting service of a pattern 10, in steps ST28 and ST29.

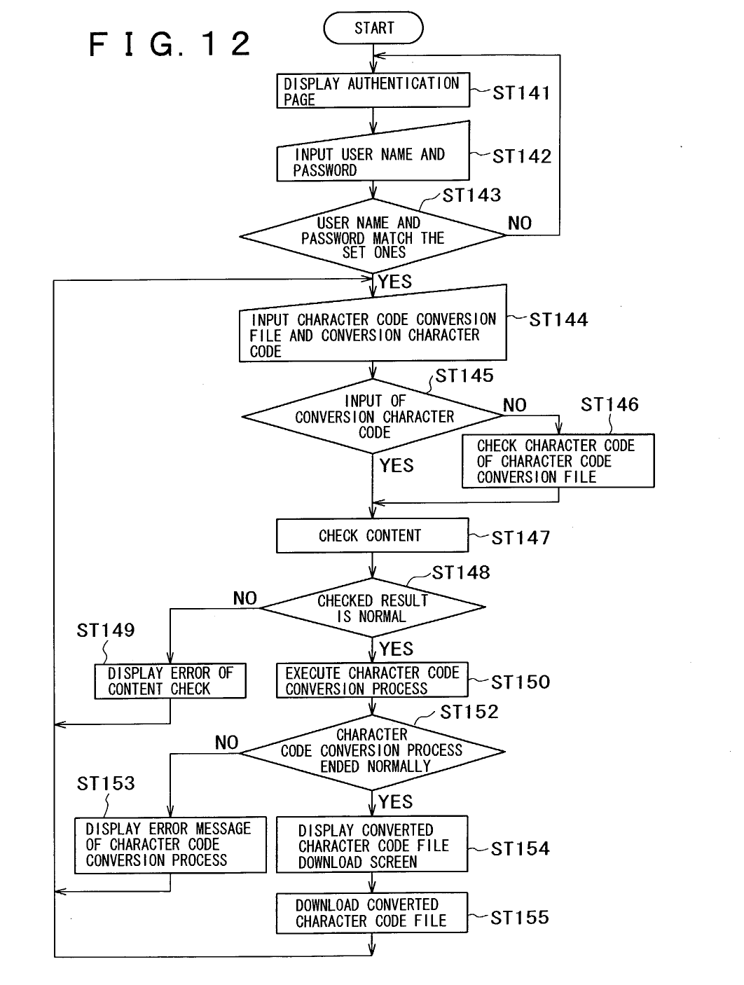

In the S-JIS/EUC-JP codes interconverting service routine, as shown in FIG. 12, a display screen of an authentication page is first displayed, in step ST141.

The display screen of the authentication page is the above-mentioned screen shown in FIG. 13 (the authenticated screen 57 shown in FIG. 2), and is configured to input the user ID 61 and the password 62.

Then, after the user ID 61 and the password 62 have been input, it is checked whether the input user ID 61 and the password 62 match previously set data or not, in steps ST142 and ST143. When they match respectively, a character code conversion file and a conversion character code are input, in step ST144.

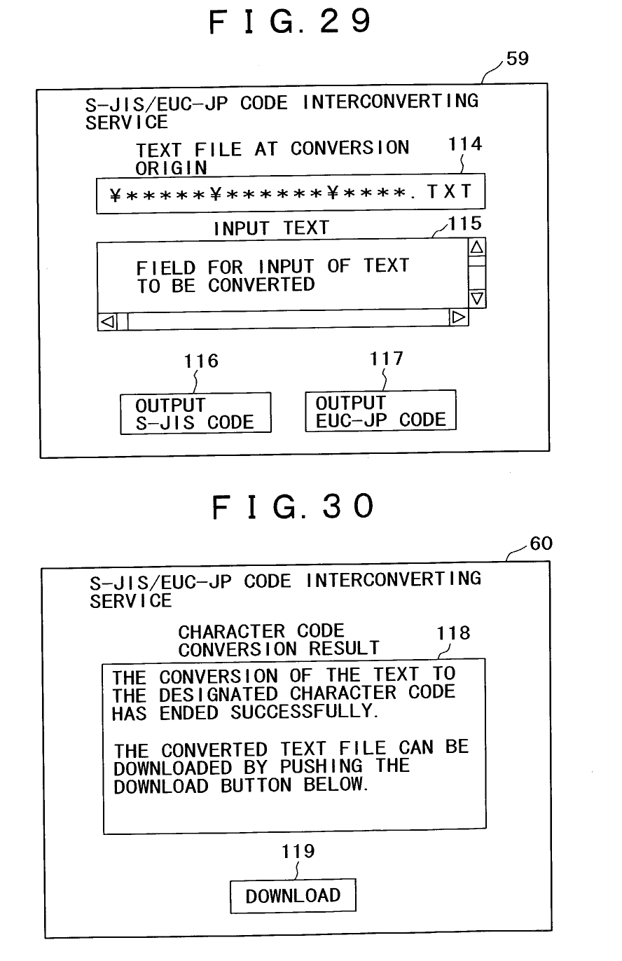

At this input, an input screen shown in FIG. 29 (the S JIS/EUC JP codes interconverting service authentication screen 56 in FIG. 2) is displayed. In the input screen, the title of “S-JIS/EUC-JP CODES INTERCONVERTING SERVICE” is displayed. Next, an icon for an input of a text file to be converted 114 and a field for an input of a text to be converted 115 are displayed. If the inputs are appropriately performed and an S-JIS code output key 116 or an EUC-JP code output key 117 is clicked, then the input text file can be converted to a file having the designated code.

If the input of the conversion character code has not yet performed in such a way, then the character code of the character code conversion file is checked, in steps ST145 and ST146.

If it is judged at the step ST145 that the conversion character code has already been input, then a check of content is performed, in step ST147. If a result of the check indicates that the content is not normal, then the error of the content check is displayed, in steps ST148 and ST149. Then, the process of the digital data broadcasting program producing apparatus returns to the step ST144, and an input operation is again performed.

If a check result at the step ST148 indicates that the content is normal, then a character code conversion process is next performed, in step ST150.

If the character code conversion process has not performed successfully, then an error message of the character code conversion process is displayed, in steps ST152 and ST153. Then, the process of the digital data broadcasting program producing apparatus returns to the step ST144, and the next input operation is performed.

If the character code conversion process is judged as ended successfully at the step ST152, then a converted character code file download screen is displayed, and a converted character code file is downloaded by a predetermined operation such as clicking, in steps ST154 and ST155.

The converted character code file download screen is a screen shown in FIG. 30 (the character code conversion result display screen 59 and the converted character code file download screen 60 shown in FIG. 2). In the screen, the title of “S-JIS/EUC-JP CODES INTERCONVERTING SERVICE” is displayed, and a character code conversion result 118 and a download key 119 are displayed.

Here, a character code conversion result is displayed in a way such that “The conversion of the text to the designated character code has ended successfully.”, “The converted text file can be downloaded by pushing the download button below.”, and the like.

Then, if the download key 119 is clicked, then the converted character code conversion file can be downloaded.

The digital data broadcasting program producing apparatus which is thus configured and thus operates, has advantages which a user of the service on the client side can enjoy and advantages which a service enterpriser who constructs a Web server can enjoy. Both the advantages will be enumerated in the following.

The advantages which a user of services on the client side connection terminal 11 can enjoy are as follows.

(1) It becomes unnecessary to purchase expensive content producing applications as much as the number of computers for the execution of development. As a result, it becomes possible to reduce the amount of investment for purchasing software.

(2) If a certain specific function is needed, then it is not necessary to purchase the software including the function, but it is enough to purchase only the specific necessary function. Consequently, it becomes possible to use the necessary function with a minimum of investment.

(3) Owing to the fact that the user of the services uses various services, the cost of content and the number of man-hours of development are sharply reduced. Thereby, costs and the number of man-hours of human resources can be reduced.

(4) Because it is unnecessary to install content producing software in a computer, the maintenance and the management of the computer are very simple and easy.

(5) All computers can produce content as long as they can be connected with a network. Consequently, it becomes unnecessary to prepare a computer to be used exclusively for producing content.

(6) Content can be produced at any place regardless of the place as long as a computer for producing the content is in an environment in which the computer can be connected to a network.

(7) Even if the standards regulated by the ARIB are changed, or if software is updated, it is sufficient only that an application on a server is updated. Consequently, the user of the services can perform development of content without having to worry about the update.

(8) In the above-mentioned case, the user of the services can produce content with the latest content producing application.

(9) Because produced content can be stored in a Web server, various computers can produce content.

(10) Owing to the fact that the user of the services uses only a necessary function among each service, each service can be used as a content production tool.

(12) Owing to the fact that the user of the services uses all of the services, a content can be produced smoothly in a short time span with high reliability.

The advantages that a service enterpriser who constructs the Web server 13 may enjoy are as follows.

(1) Because the content producing application basically operates on a server, the need of performing development in various kinds of machines and tests in various operation environments decreases. Thereby, the number of man-hours for development can be reduced.

(2) Because the packaging of a content producing application is unnecessary, the number of man-hours and the estimated cost for the packaging can be reduced.

(3) When the standards regulated by the ARIB are updated, or an application is updated, the latest service can be provided to a user only by updating the applicaton registered in the Web server 13.

(4) It is unnecessary to update the application to all users of the services by performing the above-mentioned process. Consequently, the number of man-hours for producing a package for updating and installing the updated application can be reduced.

(5) It becomes possible to perform rapid support even in case of content development at a remote location by using a network.

Next, the digital data broadcasting program producing apparatus according to a second preferred embodiment of the present invention will be described by reference to the attached drawings. It is to be noted that, the same components as those described in the digital data broadcasting program producing apparatus of the first preferred embodiment of the present invention described above are designated by the same reference numerals as those of the first preferred embodiment of the present invention, and the descriptions of the components will be appropriately omitted.

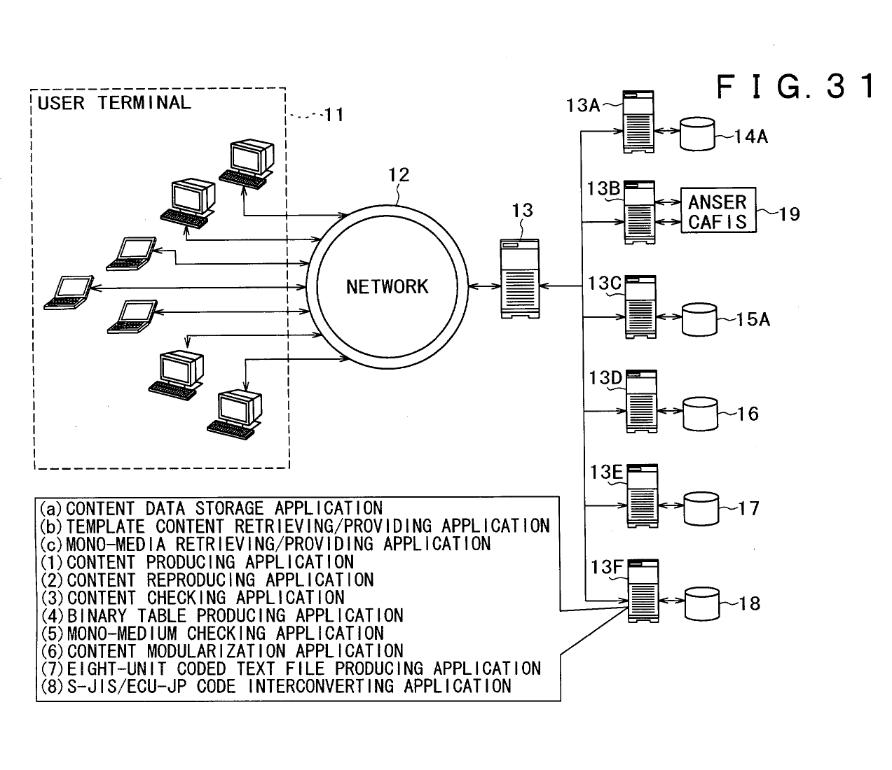

The digital data broadcasting program producing apparatus according to the second preferred embodiment of the present invention is configured, as shown in FIG. 31, to manage applications for producing the content of data broadcasting programs, the produced content and the like by servers that are functionally dispersed. The digital data broadcasting program producing apparatus is roughly composed of client side connection terminals 11 as user terminals, and a Web server 13. The client side connection terminals 11 are composed of a plurality of connection terminals which are connectable to each other through a network 12 such as the Internet and the like and are arbitrarily dispersed geographically. The Web server 13 is connectable to the network 12 such as the Internet and the like, and can access the client side connection terminals 11.

The Internet is used as the network 12 in the present example of preferred embodiment of the present invention. However, the network 12 is not limited to the Internet. It is needless to say that the network 12 may be one composed of, for example, a dedicated line, a local area network (LAN), a wide area network (WAN) and the like. Here, the dedicated line indicates a line to be exclusively used for data communication between certain specific two points. Although a terminal cannot communicate with terminals from various locations through the dedicated line like through a conventional telephone line, a charged amount for using the dedicated line can be constant regardless of connection time, communication fees and the like. A LAN is a network for exchanging data among computers and the like a the same building, for example, upon the use of twisted pair cables, coaxial cables, optical fibers and the like. WAN is used to exchange data among computers located at geographically distant points and connected to each other by point to point by means of telephone lines, dedicated lines and the like.

The Web server 13 is configured to include a user management server 13A for managing the user ID, the passwords and the like of users of the client side connection terminals 11, an account server 13B for charging for the software and the like used by a client side connection terminal, a content management server 13C for managing the content of data broadcasting programs produced by the client side connection terminals 11, a template content management server 13D for managing templates being basic content frames as bases for producing the content of data broadcasting programs, a mono-medium management server 13E for managing various mono-media, and an application server 13F for storing various applications for producing content on the Web.

The user management server 13A is configured so as to include a user management information storage section 14A for storing user ID, passwords and the like for performing an authentication action of the client side connection terminals 11.

The account server 13B is a server for performing a centralized management of various fees generated in connection with productions of content such as the rental fees of the applications which client side connection terminals 11 have used, registration fees, management fees for managing content, and the like. The account server 13B electrically settles its accounts in the state of being connected with electrical commercial transaction system 19 such as existing Automatic answer Network System for Electrical Request (ANSER), Credit And Finance Information Switching system (CAFIS) and the like.

The content management server 13C is a server for storing and managing the content produced by the client side connection terminals 11 on the Web. The content management server 13C is used for replacing a part of the existing content or changing a portion thereof, and is configured to include a content storing accumulation section 15A for accumulating the content.

The template content management server 13D is a server for storing and managing template materials being basic content frames as content bases to be used for producing the content. The template content management server 13D is configured to include a template content management information accumulation section 16 for accumulating the template materials.

The mono-medium management server 13E is a server for managing various mono-media, and is configured to include a mono-medium management information accumulation section 17 for accumulating various mono-media.

Here, the mono-medium is an independent representation medium such as a picture, a static image, a graphic, audio content, a character and the like. The mono-medium is a representation medium that can perform only on the basis of its own data without having to refer to other media. Among the mono-media having such features, the present example of preferred embodiment of the present invention includes a moving picture in accordance with Moving Picture Experts Group 1 (MPEG-1), a moving picture in accordance with Moving Picture Experts Group 2 (MPEG-2), a frame picture in accordance with Moving Picture Experts Group 2 I (MPEG-2-I), and files concerning Joint Photographic Coding Experts Group (JPEG), Portable Network Graphics (PNG), Multiple Image Network Graphics (MNG), audio in accordance with MPEG-2 or Audio Interchange File Format-C (AIFF-C), and audio in accordance with Moving Picture Experts Group 4 (MPEG-4).

It is to be noted that other mono-media may be appropriately changed or modified or combined without being limited to the mono-media referred herein.

The application server 13F is a server for managing and operating various applications to be used at the time of producing the content of data broadcasting programs. The application server 13F is configured to include an application management information accumulation section 18 for accumulating the applications.

The applications in the present example of preferred embodiment of the present invention are (a) a content data storage application, (b) a template content retrieving/providing application, (c) a mono-media retrieving/providing application, (1) a content producing application, (2) a content reproducing application, (3) a content checking application, (4) a binary table file producing application, (5) a mono-medium checking application, (6) a content modularization application, (7) an eight-unit coded text file producing application and (8) an S-JIS/ECU-JP codes interconverting application.

It is to be noted that, the applications are not limited to the applications referred herein. As applications necessary for producing content, the above-mentioned applications can be changed or updated whenever required, at any time. Moreover, new applications may be provided or, in other words, the application server 13F is configured so as to contribute recursively to content production.

The digital data broadcasting program producing apparatus according to the second preferred embodiment of the present invention configured as described above can realize the production, the reproduction and various services of content on the Web. In the present example of preferred embodiment of the present invention, the services are available on a network, more specifically, the Internet. All of the application groups to be exclusively used for the services to be used reside on the application server 13F which is connectable to the Web server 13.

In addition, it becomes possible for a user of the services of the client side connection terminals 11 to use the services upon accessing the Web server 13 by designation and then upon authentication thereof through the network 12.

Because it is unnecessary for the user of the services of the client side connection terminals 11 to install the applications to be exclusively used for the services into his or her network connecting terminal for using the services at the time of using the services, it is possible to use the services with all of the network connecting terminals connectable with the network 12.

All of the present services always require an authentication procedure at the time of the execution of the services. In the authentication procedure, a user name and password are input, and the input information is collated with the customer management information on the user management server 13A connectable with the Web server 13. Thus, only the user whose name and password match the customer management information can use the services.

Moreover, in all of the services, it is possible to store the file groups produced at the time of using the services in the content management server 13C connectable with the Web server 13. The stored file groups can be arbitrarily uploaded or downloaded with a network connecting terminal.

Moreover, the account system for charging a service rental fee and the like is managed by the account server 13B connectable with the Web server 13. The account server 13B electrically settles its accounts upon being connected with the above-mentioned electrical commercial transaction system 19 such as ANSER, CAFIS and the like.

Moreover, a user of services on the client side can enjoy a data content producing environment by using the following services of (A), (B), (1) to (11), and thereby it becomes possible for the user to produce data content capable of being broadcast at a low cost and with high functions.

Then, it becomes possible for the user of the services on the client side to enjoy the functions of performing complicated processes for developing the content of data broadcasting programs by using each of the following services of (A), (B), (1) to (11).

(A) template content providing service

(B) mono-media providing service

(1) content data storage service

(2) content producing service

(3) content reproducing service

(4) content checking service

(5) binary table file producing service

(6) mono-medium checking service

(7) content modularization service

(8) eight-unit coded text file producing service

(9) S-JIS/EUC-JP codes interconverting service

The services necessary for respective productions by the use of the digital data broadcasting program producing apparatus capable of enjoying such various services overlap the ones described in connection with the above-mentioned first preferred embodiment of the present invention. The overlapping services are: (1) the content data storage service, (2) the content producing service, (3) the content reproducing service, (4) the content checking service, (5) the binary table file producing service, (6) the mono-media checking service, (7) the content modularization service, (8) the eight-unit coded text file producing service and (9) the S JIS/EUC JP codes interconverting service. These services are designated by the same reference numerals, and the descriptions concerning them are omitted.

The newly added services in the second embodiment are (A) the template content providing service and (B) the mono-media providing service. These services will be described in the following.

(A) Template Content Providing Service

In the template content providing service, an authentication screen is displayed. Then, a user name and password is input. After that, if the input user name and password match-the user management information accumulated in the user management server 13A connectable with the Web server 13, then a screen for designating the retrieving conditions for a template content residing in the template content management server 13D is displayed. Then, the user on the client side designates the retrieving conditions. The template content in the template content management server 13D is next retrieved on the basis of the designated conditions. The summaries of detected templates are displayed together with download buttons. Next, the user pushes the download button of the template content, which the user wants to download in the table of the detected templates. Thus, it is possible to download the template content to the terminal of the user.

(B) Mono-Media Providing Service

In the mono-media providing service, an authentication screen is displayed. Then, a user name and password are input. After that, if the input user name and password match the user management information on the client side accumulated in the user management server 13A connectable with the Web server 13, then a screen for designating the retrieving conditions for a mono-medium resideing in the mono-medium management sever 13E is displayed. Then, the user designates the retrieving conditions.

The mono-medium in the mono-medium management server 13E is next retrieved on the basis of the designated conditions. The summaries of detected mono-media are displayed together with download buttons. Next, the user pushes the download button of the mono-medium which the user wants to download in the table of the detected mono-media. Thus, it is possible to download the mono-medium to the terminal of the user.

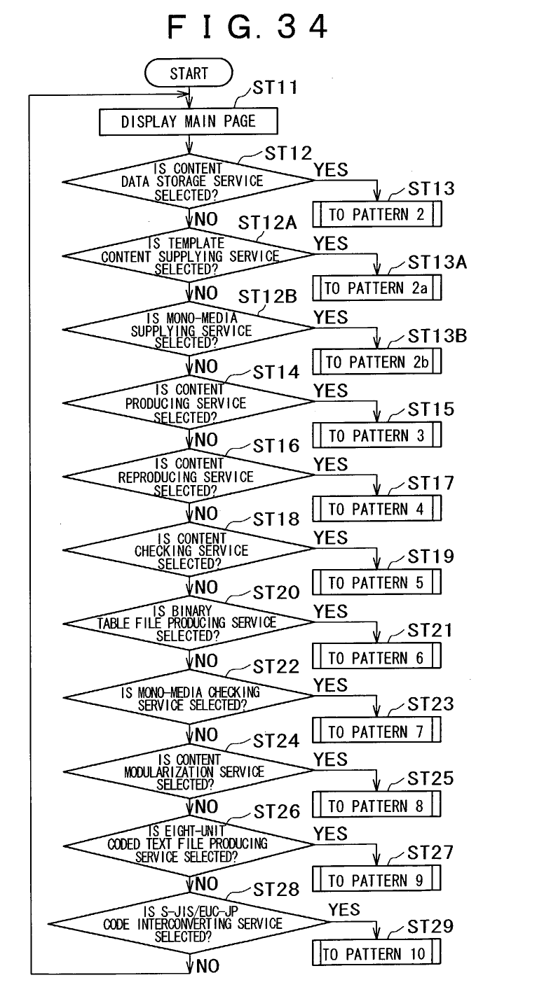

The operation of the digital data broadcasting program producing apparatus according to the second preferred embodiment of the present invention capable of performing such various services will be described in the following by reference to the block diagrams of FIG. 31 to FIG. 33 and the flow charts of FIG. 34 to FIG. 36.

It is to be noted that, as described above, the present system is made to be capable of displaying various pages necessary for the content of a data broadcasting program on a screen of a client side connection terminal 11. Then, desired information on the pages are selected and designated, or input. Thereby, the content of the data broadcasting program is produced.

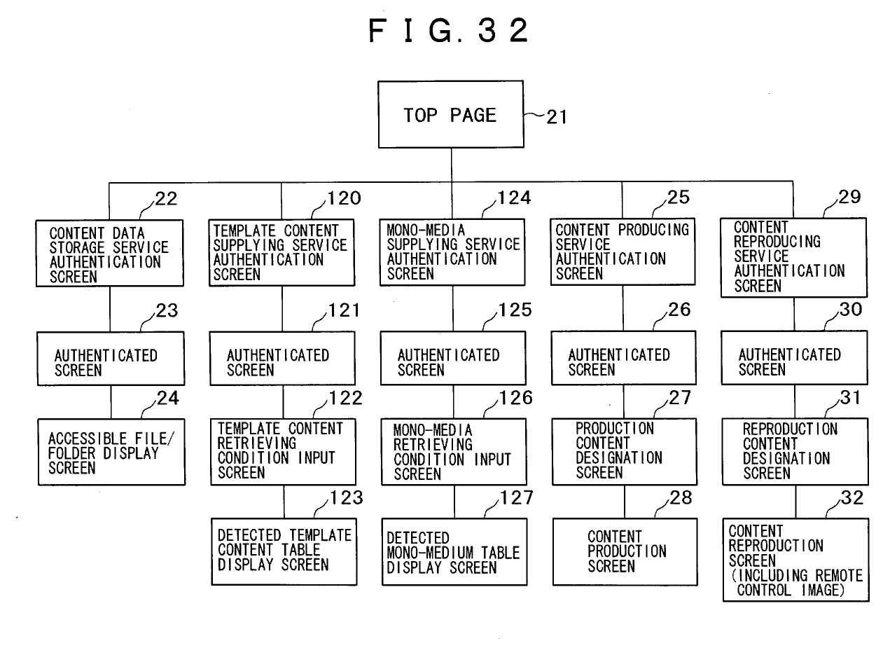

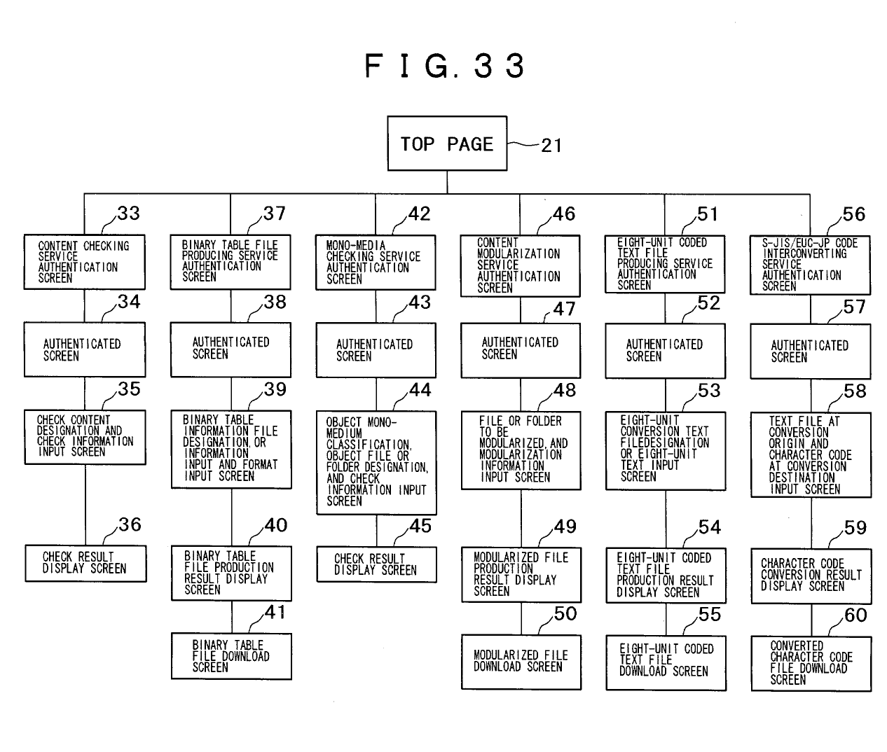

First, as shown in FIGS. 32 and 33, in various display screens to be displayed on a screen of a client side connection terminal 11, low order hierarchical display screens are gradually displayed hierarchically in conformity with instructions on the displayed screen by selection of eleven head display screens in a TOP page 21, and then the content of a data broadcasting program is produced by performing the operations such as selection, designation, inputting of information and the like.

The head display screens selectable in the TOP page 21 are composed of a “content data storage service authentication screen” 22, a “template content supplying service authentication screen” 120, a “mono-media supplying service authentication screen” 124, a “content producing service authentication screen” 25, a “content reproducing service authentication screen” 29, a “content checking service authentication screen” 33, a “binary table file producing service authentication screen” 37, a “mono-media checking service authentication screen” 42, a “content modularization service authentication screen” 46, an “eight-unit coded text file producing service authentication screen” 51 and an “S-JIS/EUC-JP character codes interconverting service authentication screen” 56. In the following, their operations will be described in order when they are selected.

When the “content data storage service authentication screen” 22 is selected, an “authenticated screen” 23 and an “accessible file/folder display screen” 24 follow as its low order screens.

When the “template content supplying service authentication screen” 120 is selected, an “authenticated screen” 121, a “template content retrieving condition input screen” 122 and a “detected template content table display screen” 123 follow as its low order screens.

When the “mono-media supplying service authentication screen” 124 is selected, an “authenticated screen” 125, a “mono-media retrieving condition input screen” 126 and a “detected mono-medium table display screen” 127 follow as its low order screens.

When the “content producing service authentication screen” 25 is selected, an “authenticated screen” 26, a “production content designation screen” 27 and a “content production screen” 28 follow as its low order screens.

When the “content reproducing service authentication screen” 29 is selected, an “authenticated screen” 30, a “reproduction content designation screen” 31 and a “content reproduction screen” 32 (including a remote control image) follow as its low order screens.

When the “content checking service authentication screen” 33 is selected, an “authenticated screen” 34, a “check content designation and check information input screen” 35 and a “check result display screen” 36 follow as its low order screens.

When the “binary table file producing service authentication screen” 37 is selected, an “authenticated screen” 38, a “binary table information file designation, or information input and format input screen” 39, a “binary table file production result display screen” 40 and a “binary table file download screen” 41 follow as its low order screens.

When the “mono-media checking service authentication screen” 42 is selected, an “authenticated screen” 43, an “object mono-medium classification, object file or folder designation, and check information input screen” 44 and a “check result display screen” 45 follow its low order screens.

When the “content modularization service authentication screen” 46 is selected, an “authenticated screen” 47, a “file or folder to be modularized, and modularization information input screen” 48, a “modularized file production result display screen” 49 and a “modularized file download screen” 50 follow as its low order screens.

When the “eight-unit coded text file producing service authentication screen” 51 is selected, an “authenticated screen” 52, an “eight-unit conversion text file designation or eight-unit coded text input screen” 53, an “eight-unit coded text file production result display screen” 54 and an “eight-unit coded text file download screen” 55 follow as its low order screens.

When the “S-JIS/EUC-JP codes interconverting service authentication screen” 56 is selected, an “authenticated screen” 57, an “text file at conversion origin and character code at conversion destination input screen” 58, a “character code conversion result display screen” 59 and a “converted character code file download screen” 60 follow as its low order screens.

By the appropriate selection of screens for generating material data to produce content displayed in the TOP page 21, the desired content can be produced. Now, because (1) the content data storage service, (2) the content producing service, (3) the content reproducing service, (4) the content checking service, (5) the binary table file producing service, (6) the mono-media checking service, (7) the content modularization service, (8) the eight-unit coded text file producing-service and (9) the S JIS/EUC JP codes interconverting service are the same as ones described in connection with the flow charts shown in FIGS. 3-12 concerning the above-mentioned first preferred embodiment of the present invention, the descriptions thereof are omitted. Accordingly, (A) the template content supplying service and (B) the mono-media supplying service will be described in the following.

When a user selects the template content supplying service while viewing the display screen in the TOP page 21 in FIG. 34, the process of the digital data broadcasting program producing apparatus proceeds to the routine of the template content supplying service of a pattern 2a, in steps ST12A and ST13A.

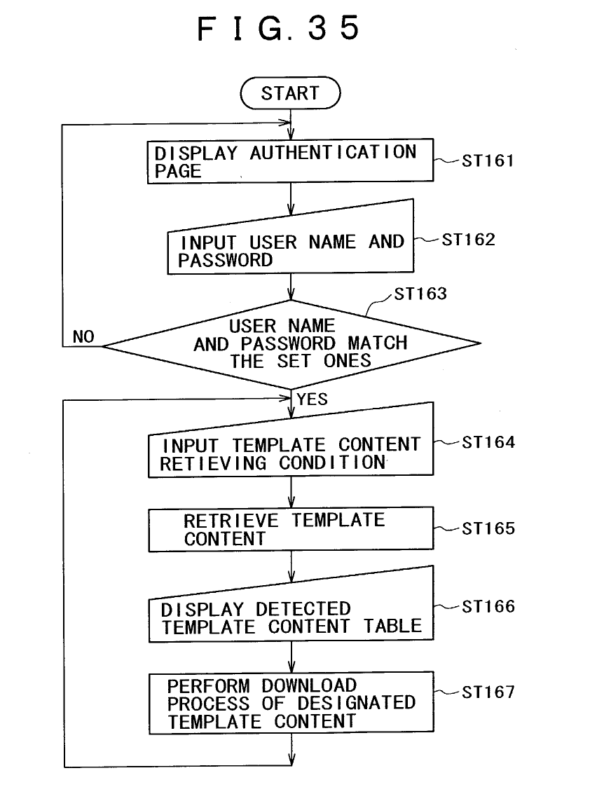

In the routine of the template content supplying service, as shown in FIG. 35, a display screen of an authentication page is first displayed, in step ST161.

The display screen of the authentication page is the screen described in connection with the first preferred embodiment of the present invention and shown in FIG. 13 (the authenticated screen 121 shown in FIG. 32), and is configured to input user ID and a password.

Then, after a user inputs his or her user ID and password, it is checked whether the input user ID and the password match previously set data or not, in steps ST162 and ST163. If the input user ID and the password match the set data, then the user inputs template content retrieving conditions, in step ST164.

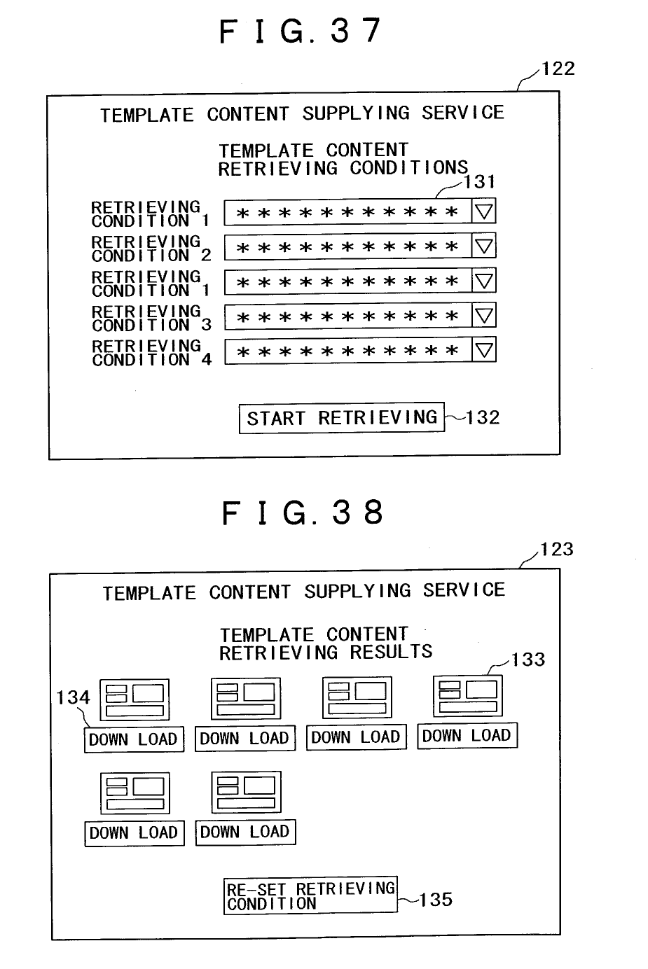

The inputting is performed into a displayed input screen shown in FIG. 37 (the template content retrieving condition input screen 122 shown in FIG. 32). In the screen, the title of “TEMPLATE CONTENT SUPPLYING SERVICE” is displayed. Moreover, icons for inputting template content retrieving conditions 131 and a retrieval start key 132 are displayed.

After the input of the template content retrieving conditions in such a way, the template content is next retrieved. The result of the retrieval is displayed in a table. Then, it is possible to download the designated template content, in steps ST164, ST165, ST166 and ST167.

The display screen for displaying the content retrieval results and for downloading the detected content is a screen shown in FIG. 38 (the detected template content table display screen shown in FIG. 32). In the screen, the title of “TEMPLATE CONTENT SUPPLYING SERVICE” is displayed, and template content retrieving results 133 are displayed. Also, download keys 134 for each retrieved content are displayed. Moreover, a retrieving conditions re-setting key 135 for performing retrieval again is also displayed.

By clicking a download key 134 to the desired template content, the user can download the template content.

In FIG. 34 again, if the template content supplying service is not selected at the step ST12A, then the selection of a mono-media supplying service is next examined, in step ST12B. If the mono-media supplying service is selected, then the process of the digital data broadcasting program producing apparatus proceeds to the routine of the mono-media supplying service of a pattern 2b, in steps ST12B and ST13B.

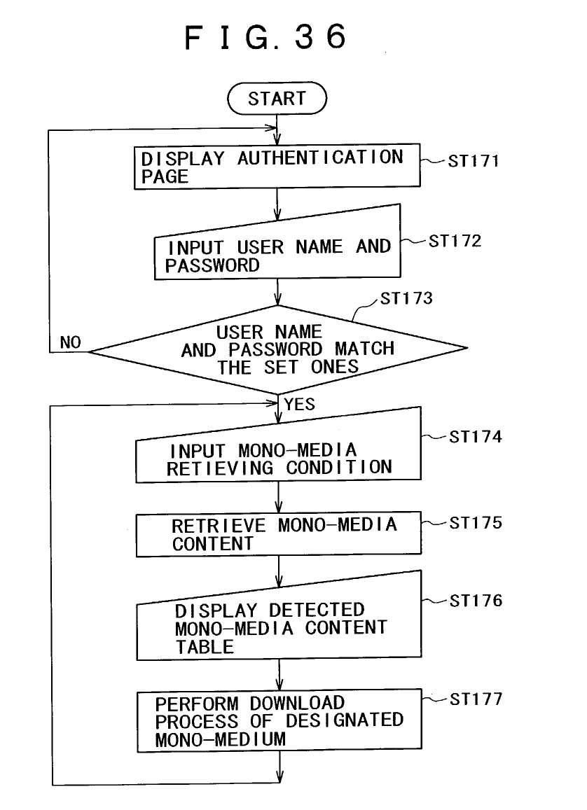

In the routine of the mono-media supplying service, as shown in FIG. 36, a display screen of an authentication page is first displayed, in step ST171.

The display screen of the authentication page is similar to the screen that has been described in connection with the above-mentioned first preferred embodiment of the present invention and is shown in FIG. 13 (the authenticated screen 125 shown in FIG. 32), and the display screen is configured to input the user ID 61 and the password 62.

Then, after the user ID 61 and the password 62 have been input, it is checked whether the input user ID 61 and the password 62 match previously set data or not, in steps ST172 and ST173. When they respectively match, mono-media retrieving conditions are input, in step ST174.

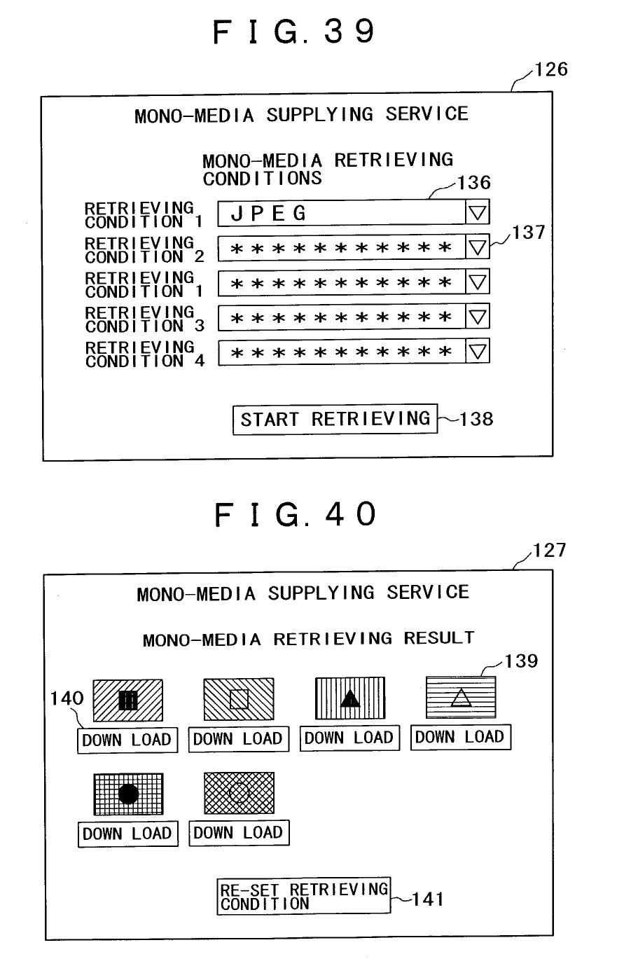

The input of the mono-media retrieving conditions is performed in an input screen shown in FIG. 39 (the mono-media retrieving condition input screen 126 shown in FIG. 32). In the input screen, the title of “MONO-MEDIA SUPPLYING SERVICE” is displayed, and an icon for inputting the type of medium 136, icons for inputting retrieving conditions 137 as the mono-media retrieving conditions, and a retrieval start key 138 are displayed. In the input screen shown in FIG. 39, “JPEG” is selected as the type of medium 136 in the present example of preferred embodiment of the present invention.

After the mono-media retrieving conditions have been input in such a way, the mono-media are retrieved next. The results of the retrieval are displayed as a table. Consequently, it becomes possible to download designated mono-media among the mono-media displayed in the table, in steps ST175, ST176 and ST177.

The screen display for displaying the retrieval results and for downloading them is a screen shown in FIG. 40 (the mono-media retrieving condition input screen 126 and detected mono-medium table display screen 127 shown in FIG. 32). In the screen display, the title of “MONO-MEDIA SUPPLYING SERVICE” is displayed, and mono-media retrieving results 139 are displayed. Moreover, download keys 140 for each of retrieved content are displayed. Moreover, retrieving conditions re-setting key 141 is also displayed.

Then, the user can download the mono-medium content upon clicking the download key 140 to the desired mono-medium content.

Finally, although the present invention having been described hereinabove in in its preferred form with a certain degree of particularity, other changes, variations, combinations and sub-combinations are possible therein. It is therefore to be understood that any modifications will be practiced otherwise than as specifically described herein without departing from the scope and spirit of the present invention.

What is claimed is:

1. A digital data broadcasting program producing apparatus connected with a client terminal at a client side through a network, said apparatus comprising:
storage means for storing data broadcasting program producing software; and
control means for controlling said data broadcasting program producing software in order to produce a data broadcasting program based on an instruction from said client terminal.

2. The digital data broadcasting program producing apparatus according to claim 1, further comprising a memory for storing content of said data broadcasting program.

3. The digital data broadcasting program producing apparatus according to claim 1, wherein said data broadcasting program producing software comprises a content checking application for performing a check of validity of content in accordance with a standard pertaining to data broadcasting programs, and a check of a character code described in said content.

4. The digital data broadcasting program producing apparatus according to claim 1, wherein said data broadcasting program producing software comprises a binary table producing application for producing a binary table file in response to performing one of a designation of an information file for producing the binary table file on the Web, an input of various pieces of information as elements of the binary table file, and a designation of a binary table format; and, when said binary table format is designated at a time of producing the binary table file, another binary table file is produced upon checking consistency between the binary table format and various types of information related to the production of said binary table.

5. The digital data broadcasting program producing apparatus according to claim 4, wherein, when no binary table format is designated at the time of producing the binary table file, a binary table format is automatically generated based on various types of information related to the production of said binary table, and another binary table file is produced based on said automatically generated binary table format.

6. The digital data broadcasting program producing apparatus according to claim 1, wherein said data broadcasting program producing software comprises a mono-media checking application for checking at least one of a combination of an MPEG-1 format moving picture file, an MPEG-2 format moving picture file, an MPEG-2-I frame format picture file, a JPEG format picture file, a PNG format picture file, an MNG format picture file, an MPEG-2 format audio file, a PCM (AIFF-C) format audio file and an MPEG-4 format audio file, based on a standard related to a data broadcasting program and an arbitrarily determined checking reference information.

7. The digital data broadcasting program producing apparatus according to claim 1, wherein said data broadcasting program producing software comprises a content modularization application for indicating a folder on a WEB containing a file or a group of files to be modularized and for indicating information required for performing the modularization, wherein checking is performed through said content check application and said mono-media check application and, when no abnormality is detected, a generation process is performed on the file to be modularized.

8. The digital data broadcasting program producing apparatus according to claim 1, wherein said data broadcasting program producing software comprises a coded text file producing application for producing a coded text file in response to one of designation of a file to be converted to a coded text file from a Web, and input of a file from which an actual coded image is produced.

9. The digital data broadcasting program producing apparatus according to claim 1, wherein said data broadcasting program producing software comprises a character converting application for converting a designated file to a selected character code, after designation of a file to be submitted to character conversion and selection of a character code of destination, to which said file is converted.

10. The digital data broadcasting program producing apparatus according to claim 9, wherein said character converting application automatically selects a character code of origin if no character code is selected as said character code of destination and converts said character code of origin to a character code constituting a pair of character code with said character code of origin.

11. The digital data broadcasting program producing apparatus according to claim 9, wherein said data broadcasting program producing software further comprises a content checking application, and, when an abnormality is detected through a content check carried out by said content checking application, said character converting application sends a notification on said abnormality and stops the character code conversion process.

12. A broadcasting program producing apparatus connected with a client terminal at a client side through a network, the apparatus comprising:
a Web server for accessing said network and connecting with said client terminal, said Web server acquiring information by having connection with:
a user management server including user management information for authentication of said client,
an account server for settling charges generated at a time of producing content of a data broadcasting program,
a content management server for storing and managing said content of said data broadcasting program,
a template content management server for managing and operating a template to be used at the time of producing said content of said data broadcasting program,
a mono-medium management server for managing and operating a mono-medium to be used at the time of producing said content of said data broadcasting program, and
an application server for managing and operating software for producing a data broadcasting program; wherein
said Web server is connected with said user management server to perform authentication of said client; and
content of a data broadcasting program is produced on a Web by utilizing said software for producing data broadcasting program residing in said application server.

13. The digital data broadcasting program producing apparatus according to claim 12, wherein
said software for producing a data broadcasting program comprises a template content application;
said template content management server is accessed upon designation of a retrieving condition on a template content retrieval screen;
said template content satisfying said designated retrieving condition is displayed on a list; and
a template content designated from said displayed list is downloaded to said client terminal.

14. A digital data broadcasting program producing apparatus including an Internet connecting terminal at a client side and a Web server capable of establishing connection with said Internet connecting terminal through access to the Internet, said Internet connecting terminal provided with an Internet connecting function, said Internet connecting terminal capable of producing content of a data broadcasting program, wherein
said Web server includes:
a software program for producing a data broadcasting program;
user management information; and
a user content storing section for storing said content of said data broadcasting program produced by said Internet connecting terminal;
said Web server performs authentication of said client on a basis of said user management information; and
said Internet connecting terminal produces said content of said data broadcasting program on the Web in response to utilizing said software residing in said Web server, for producing said data broadcasting program.

15. A digital data broadcasting program producing apparatus including an Internet connection to a terminal at a client side and a Web server capable of establishing connection with said Internet connecting terminal through access to the Internet, said Internet connecting terminal provided with an Internet connecting function and having capability to produce content of a data broadcasting program, wherein
said Web server acquires desired information by having connection with:
a user management server including user management information for authentication of said client,
an account server for settling charges generated at a time of producing content of a data broadcasting program,
a content management server for storing and managing said content of said data broadcasting program,
a template content management server for managing and operating a template to be used at the time of producing said content of said data broadcasting program,
a mono-medium management server for managing and operating a mono-medium to be used at the time of producing said content of said data broadcasting program, and
an application server for managing and operating software for producing a data broadcasting program; wherein
said Web server is connected with said user management server to perform authentication of said client; and
content of a data broadcasting program is produced on a Web by utilizing said software for producing data broadcasting program residing in said application server and transmitted through said Web server.
